(19) United States
(12) Patent Application Publication
(10) Pub. No.: US 2024/0272533 A1
(43) Pub. Date: Aug. 15, 2024

(54) LIGHT SOURCE CONTROL DEVICE, LIGHT SOURCE DEVICE, PROJECTOR, AND METHOD OF CONTROLLING LIGHT SOURCE

(71) Applicant: SEIKO EPSON CORPORATION, Tokyo (JP)

(72) Inventors: Kosuke TABAYASHI, Azumino-shi (JP); Norikazu Kadotani, Azumino-shi (JP)

(73) Assignee: SEIKO EPSON CORPORATION, Tokyo (JP)

(21) Appl. No.: 18/439,828

(22) Filed: Feb. 13, 2024

(30) Foreign Application Priority Data
Feb. 14, 2023 (JP) 2023-020583

(51) Int. Cl. G03B 21/16; G03B 21/20; H04N 9/31

(52) U.S. Cl. CPC G03B 21/16; G03B 21/2013; G03B 21/204; H04N 9/3155; H04N 9/3161; H04N 9/3164

(57) ABSTRACT

A light source control device configured to output illumination light includes a first light emitting element configured to output blue light, a second light emitting element configured to output red light, a wavelength conversion element configured to convert the blue light entering the wavelength conversion element into wavelength-converted light, a first thermoelectric conversion element thermally coupled to the wavelength conversion element, a first radiation member thermally coupled to the first thermoelectric conversion element, a second thermoelectric conversion element thermally coupled to the second light emitting element, a second radiation member thermally coupled to the second thermoelectric conversion element, and a controller configured to control drive of each of the first thermoelectric conversion element and the second thermoelectric conversion element.

The present application is based on, and claims priority from JP Application Serial Number 2023-020583, filed Feb. 14, 2023, the disclosure of which is hereby incorporated by reference herein in its entirety.

### BACKGROUND

### 1. Technical Field

The present disclosure relates to a light source control device, a light source device, a projector, and a method of controlling a light source.

### 2. Related Art

In the past, there has been known a light source device to be applied to a projector for projecting image light (see, e.g., JP-A-2019-45620 (Document 1) and JP-A-2012-234161 (Document 2)).

In the light source device described in Document 1, out of a blue pencil which is emitted from an array light source and then enters an optical element, blue light as s-polarized light enters a wavelength conversion element, and blue light as p-polarized light enters a second wave plate. The wavelength conversion element converts the blue light into fluorescence including green light and red light, and then emits the fluorescence, and the fluorescence passes through the optical element, and is then emitted from the light source device. The blue light as the p-polarized light having entered the second wave plate is converted into blue light as circularly polarized light, and is then diffusely reflected by a diffuse reflective element. The blue light having been reflected by the diffuse reflective element is converted into the blue light as the s-polarized light when passing through the second wave plate, and is then reflected by the optical element to be emitted from the light source device.

In the light source device described in Document 2, out of the blue light which has been emitted from an excitation light source and then entered a first dichroic mirror, the blue light as the s-polarized light enters a phosphor. The phosphor converts the blue light entering the phosphor into green light, and the green light thus converted passes through the first dichroic mirror. Out of the blue light having entered the first dichroic mirror, the blue light as the p-polarized light passes through a ¼ wave plate, and is then reflected by a second dichroic mirror, and is converted in the blue light as the s-polarized light in the process of passing through the ¼ wave plate once again. The blue light as the s-polarized light thus converted is reflected by the first dichroic mirror toward a direction in which the green light passes through the first dichroic mirror. The red light from a red laser source passes through the second dichroic mirror and the ¼ wave plate, and is then reflected by the first dichroic mirror toward a direction in which the green light passes through the first dichroic mirror.

Here, in order to maintain the wavelength conversion efficiency of incident light by the wavelength conversion element, a temperature management of the wavelength conversion element is important. However, the wavelength conversion element described in Document 1 has a configuration in which a phosphor layer is fixed on a substrate, and therefore has a problem that a radiation efficiency of the phosphor layer is low, and the temperature of the phosphor layer is apt to rise to decrease the wavelength conversion efficiency of the wavelength conversion element.

In contrast, the phosphor described in Document 2 is disposed on a rotating substrate, and is therefore capable of increasing the radiation performance of the phosphor, and is capable of preventing the deterioration of the wavelength conversion efficiency of the phosphor.

However, in the light source device described in Document 2, the red laser light source for emitting the red light to be combined with the blue light emitted from the excitation light source and the green light converted by the phosphor increases or decreases in output of the red light in accordance with the ambient temperature. Therefore, there is a problem that it is difficult to maintain the white balance of the light emitted from the light source device.

Due to these circumstances, it has been desired a configuration in which the wavelength conversion efficiency of the wavelength conversion element can be maintained, and the white balance of the outgoing light can be adjusted.

### SUMMARY

A light source control device according to a first aspect of the present disclosure is a light source control device configured to output illumination light including a first light emitting element configured to output blue light, a second light emitting element configured to output red light, a wavelength conversion element configured to convert the blue light entering the wavelength conversion element into wavelength-converted light, a first thermoelectric conversion element thermally coupled to the wavelength conversion element, a first radiation member thermally coupled to the first thermoelectric conversion element, a second thermoelectric conversion element thermally coupled to the second light emitting element, a second radiation member thermally coupled to the second thermoelectric conversion element, and a controller configured to control drive of each of the first thermoelectric conversion element and the second thermoelectric conversion element.

A projector according to a second aspect of the present disclosure includes the light source control device according to the first aspect described above, an image forming device configured to form image light from the light emitted from the light source control device, and a projection optical device configured to project the image light formed by the image forming device.

A light source device according to a third aspect of the present disclosure includes a first light source configured to output blue light, a second light source configured to output red light, a wavelength conversion device configured to convert the blue light entering the wavelength conversion device into wavelength-converted light, a color combining element configured to combine the blue light, the wavelength-converted light, and the red light with each other, a first radiation member thermally coupled to the wavelength conversion device, and a second radiation member thermally coupled to the second light source, wherein the wavelength conversion device includes a wavelength conversion element configured to convert the blue light into the wavelength-converted light, a first base which has a first surface and a second surface at an opposite side to the first surface, which supports the wavelength conversion element with the first surface, and which has thermal conductivity, and a first thermoelectric conversion element thermally coupled to the second surface, the second light source includes a light emitting element, a second base which has a third surface and a fourth surface at an opposite side to the third surface, which supports the light emitting element with the third surface, and which has thermal conductivity, and a second thermoelectric conversion element thermally coupled to the fourth surface, the first radiation member is arranged at an opposite side to the first base with respect to the first thermoelectric conversion element, and is thermally coupled to the first thermoelectric conversion element, and the second radiation member is arranged at an opposite side to the second base with respect to the second thermoelectric conversion element, and is thermally coupled to the second thermoelectric conversion element.

A projector according to a fourth aspect of the present disclosure includes the light source device according to the third aspect described above, an image forming device configured to form image light from the light emitted from the light source device, and a projection optical device configured to project the image light formed by the image forming device.

A method of controlling a light source according to a fifth aspect of the present disclosure is a method of controlling a light source to be performed on a light source device provided with a first light emitting element, a wavelength conversion element configured to output wavelength-converted light obtained by converting a wavelength of blue light input from the first light emitting element, and a second light emitting element configured to output red light to be combined with the blue light and the wavelength-converted light, the method including a first cooling step of cooling the wavelength conversion element, a second cooling step of cooling the second light emitting element, and a control step of controlling temperature of the second light emitting element based on a ratio between a light intensity of the blue light included in light output from the light source device and a light intensity of the red light included in the light output from the light source device.

### BRIEF DESCRIPTION OF THE DRAWINGS

FIG. 1 is a schematic diagram showing a configuration of a projector according to a first embodiment.

FIG. 2 is a schematic diagram showing a configuration of a light source device in the first embodiment.

FIG. 3 is a flowchart showing control processing in the first embodiment.

FIG. 4 is a flowchart showing the control processing in the first embodiment.

FIG. 5 is a flowchart showing cooling processing of a wavelength conversion element in the first embodiment.

FIG. 6 is a flowchart showing first cooling processing of a second light emitting element in the first embodiment.

FIG. 7 is a flowchart showing second cooling processing of the second light emitting element in the first embodiment.

FIG. 8 is a flowchart showing warming processing of the second light emitting element in the first embodiment.

FIG. 9 is a schematic diagram showing a configuration of a light source device in a modification of the first embodiment.

FIG. 10 is a schematic diagram showing a configuration of a light source device in a second embodiment.

### DESCRIPTION OF EXEMPLARY EMBODIMENTS

### First Embodiment

A first embodiment of the present disclosure will hereinafter be described based on the drawings.

### Schematic Configuration of Projector

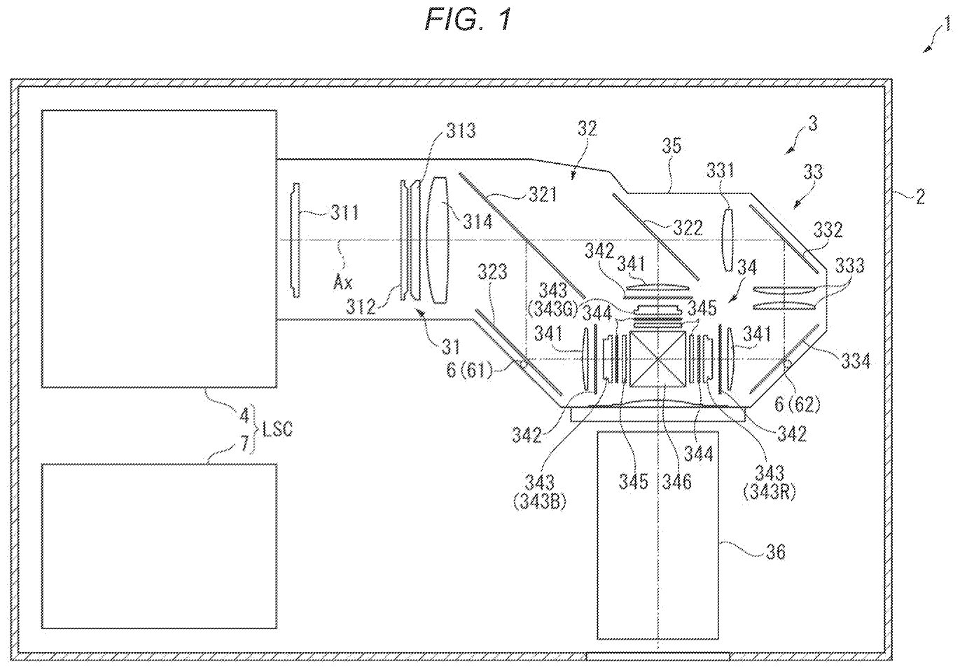

FIG. 1 is a schematic diagram showing a configuration of a projector 1 according to the present embodiment.

The projector 1 according to the present embodiment projects image light corresponding to image information on a projection target surface such as a screen in an enlarged manner. As shown in FIG. 1, the projector 1 is provided with an exterior housing 2, and an image projection unit 3, a light intensity detection unit 6, and a control unit 7 housed in the exterior housing 2. Besides the above, although not shown in the drawings, the projector 1 is provided with a power supply device for supplying electrical power to electronic components constituting the projector 1, and a cooling device for cooling a cooling target in the projector 1.

### Configuration of Image Projection Unit

The image projection unit 3 forms the image light corresponding to an image signal input from the control unit 7, and then projects the image light thus formed. The image projection unit 3 is provided with a light source device 4, a homogenizing optical system 31, a color separation optical system 32, a relay optical system 33, an image forming device 34, an optical component housing 35, and a projection optical device 36.

The light source device 4 emits illumination light to the homogenizing optical system 31. A configuration of the light source device 4 will be described later in detail.

The homogenizing optical system 31 homogenizes the illumination light emitted from the light source device 4. The illumination light thus homogenized illuminates modulation areas of light modulation elements 343 described later via the color separation optical system 32 and the relay optical system 33. The homogenizing optical system 31 is provided with two lens arrays 311, 312, a polarization conversion element 313, and a superimposing lens 314.

The color separation optical system 32 separates the light having entered the color separation optical system 32 from the homogenizing optical system 31 into colored light beams of red, green, and blue. The color separation optical system 32 is provided with two dichroic mirrors 321, 322 and a reflecting mirror 323 for reflecting the blue light having been separated by the dichroic mirror 321.

The relay optical system 33 is disposed on a light path of the red light longer than light paths of other colored light beams to suppress a loss of the red light. The relay optical system 33 is provided with an incident side lens 331, a relay lens 333, and reflecting mirrors 332, 334. In the present embodiment, it is assumed that the red light is guided to the relay optical system 33. However, this is not a limitation, and it is also possible to adopt a configuration in which, for example, the colored light beam longer in light path than other colored light beams is set as the blue light, and the relay optical system 33 guides the blue light to the image forming device 34.

The image forming device 34 forms the image light from the light emitted from the light source device 4. In the detailed description, the image forming device 34 modulates the colored light beams of red, green, and blue having entered the image forming device 34 in accordance with the image signal input from the control unit 7, and combines the colored light beams thus modulated with each other to form the image light. The image forming device 34 has three field lenses 341, three incident-side polarization plates 342, three light modulation elements 343, three field angle compensation plates 344, and three exit-side polarization plates 345 disposed in accordance with the respective colored light beams entering the image forming device 34, and a single color combining optical system 346.

The light modulation elements 343 each modulate the light, which has been emitted from the light source device 4, based on the image signal. Specifically, the light modulation elements 343 each modulate the colored light beam entering the light modulation element 343 from corresponding one of the incident-side polarization plates 342 in accordance with the image signal, and then emit the colored light beam thus modulated. The three light modulation elements 343 include a light modulation element 343R for the red light, a light modulation element 343G for the green light, and a light modulation element 343B for the blue light. In the present embodiment, the light modulation elements 343 are each a transmissive liquid crystal panel, which emits the colored light beam thus modulated along a proceeding direction of the colored light beam having entered the light modulation element 343, and a liquid crystal light valve is constituted by the light modulation element 343, the incident-side polarization plate 342, and the exit-side polarization plate 345.

The color combining optical system 346 combines the three colored light beams respectively modulated by the light modulation elements 343B, 343G, and 343R with each other to form the image light. The image light formed by the color combining optical system 346 enters the projection optical device 36. The color combining optical system 346 is constituted by a cross dichroic prism having a substantially rectangular solid shape in the present embodiment, but can be constituted by a plurality of dichroic mirrors.

The homogenizing optical system 31, the color separation optical system 32, the relay optical system 33, and the image forming device 34 all described above are housed inside the optical component housing 35. It should be noted that a light axis Ax as a design optical axis is set in the image projection unit 3, and the optical component housing 35 holds the homogenizing optical system 31, the color separation optical system 32, the relay optical system 33, and the image forming device 34 at predetermined positions on the light axis Ax. The light source device 4 and the projection optical device 36 are arranged at predetermined positions on the light axis Ax.

The projection optical device 36 projects the image light formed by the image forming device 34 on the projection target surface such as a screen. The projection optical device 36 can be configured as a combination lens provided with, for example, a plurality of lenses not shown, and a lens tube for housing the plurality of lenses. The projection optical device 36 can entirely be housed in the external housing 2, or can partially project from the external housing 2 in the exit side of the projection optical device 36.

### Configuration of Light Source Device

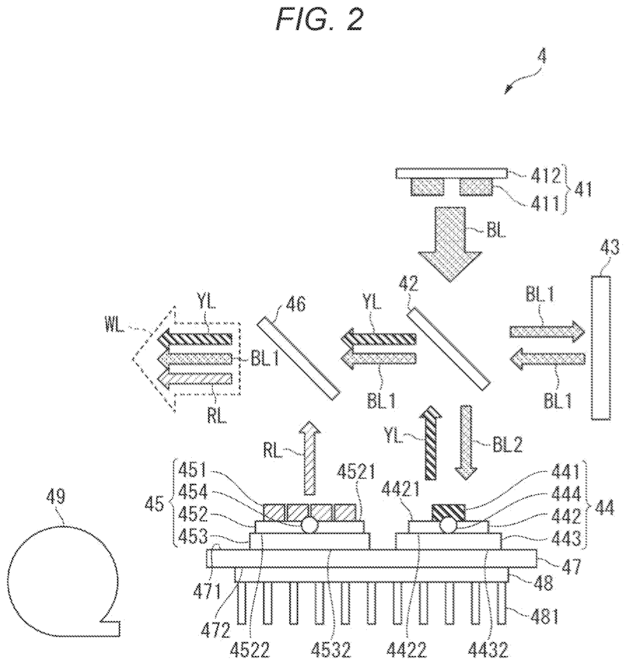

FIG. 2 is a schematic diagram showing a configuration of the light source device 4.

As shown in FIG. 2, the light source device 4 is provided with a first light source 41, a first color combining element 42, a diffuse reflective element 43, a wavelength conversion device 44, a second light source 45, a second color combining element 46, a heat receiving member 47, a radiation member 48, and a fan 49. Configuration of First Light Source

The first light source 41 outputs the blue light. The first light source 41 has at least one first light emitting element 411 and a substrate 412.

The first light emitting element 411 outputs the blue light BL. Specifically, the first light emitting element 411 is a semiconductor laser for outputting a blue laser beam having a peak wavelength of, for example, 440 nm or 460 nm, as the excitation light. It should be noted that the blue light BL to be output from the first light emitting element 411 can be the blue light including the blue light as the s-polarized light and the blue light as the p-polarized light, or can be the blue light as one of the s-polarized light and the p-polarized light. In the latter case, it is possible to dispose a 1/2 wave plate between the first light source 41 and the first color combining element 42, the 1/2 wave plate converting a part of one linearly polarized light into the other linearly polarized light.

The substrate 412 supports the first light emitting element 411, and at the same time, receives the heat of the first light emitting element 411.

### Configuration of First Color Combining Element

The first color combining element 42 separates the blue light BL output from the first light source 41.

Specifically, the first color combining element 42 reflects a part of the blue light BL output from the first light source 41, namely blue light BL1, toward the diffuse reflective element 43, and transmits the rest of the blue light BL, namely blue light BL2, toward the wavelength conversion device 44. The function of such a first color combining element 42 can be formed of a half mirror, and in addition, can be formed of a polarization separation element for reflecting one linearly polarized light, namely one of the s-polarized light and the p-polarized light, and transmitting the other linearly polarized light, namely the other of the s-polarized light and the p-polarized light.

The first color combining element 42 combines the blue light BL1 which enters the first color combining element 42 from the diffuse reflective element 43 and the wavelength-converted light YL which enters the first color combining element 42 from the wavelength conversion device 44 with each other, and then emits the result.

Specifically, the first color combining element 42 transmits the blue light BL1 which enters the first color combining element 42 from the diffuse reflective element 43, and reflects the wavelength-converted light YL which enters the first color combining element 42 from the wavelength conversion device 44, toward a direction in which the blue light BL1 is transmitted through the first color combining element 42. The function of such a first color combining element 42 can be formed of a dichroic mirror.

### Configuration of Diffuse Reflective Element

The diffuse reflective element 43 reflects the blue light BL1 having entered the diffuse reflective element 43 from the first color combining element 42 to diffuse the blue light BL1 at a diffusion angle substantially the same as the diffusion angle of the wavelength-converted light YL emitted from the wavelength conversion device 44, or a diffusion angle slightly smaller than the diffusion angle of the wavelength-converted light YL. The blue light BL1 reflected by the diffuse reflective element 43 is transmitted through the first color combining element 42.

It should be noted that it is possible to arrange a pickup lens between the first color combining element 42 and the diffuse reflective element 43, the pickup lens converging the blue light BL1 entering the pickup lens from the first color combining element 42 on the diffuse reflective element 43, and collimating the blue light BL1 entering the pickup lens from the diffuse reflective element 43.

### Configuration of Wavelength Conversion Device

The wavelength conversion device 44 converts light entering the wavelength conversion device 44 into light having a longer wavelength than the wavelength of the incident light, and then emits the result. In the present embodiment, the wavelength conversion device 44 converts the wavelength of the blue light BL2 entering the wavelength conversion device 44 to emit the wavelength-converted light YL thus converted. The wavelength conversion device 44 has a wavelength conversion element 441, a first base 442, a first thermoelectric conversion element 443, and a first temperature sensor 444.

The wavelength conversion element 441 is a phosphor layer including a phosphor for converting the wavelength of the blue light BL2 entering the wavelength conversion element 441 through the first color combining element 42, and diffuses and then emits the wavelength-converted light YL as unpolarized light obtained by converting the blue light BL2. It should be noted that the wavelength-converted light YL is light including the green light of, for example, 550 nm. However, this is not a limitation, the wavelength-converted light YL can be light which has a peak wavelength in a range of, for example, 500 through 700 nm, and which includes the green light and the red light.

The first base 442 has a first surface 4421, and a second surface 4422 at an opposite side to the first surface 4421. The first base 442 supports the wavelength conversion element 441 with the first surface 4421. The first base 442 is formed of, for example, metal, and has thermal conductivity. Therefore, the first base 442 releases the heat, which is transferred from the wavelength conversion element 441, from the second surface 4422.

In the present embodiment, the first surface 4421 is a reflecting surface for reflecting the light entering the first surface 4421 from the wavelength conversion element 441. However, this is not a limitation, and it is possible to dispose a reflecting layer for reflecting the light entering the reflecting layer from the wavelength conversion element 441 between the wavelength conversion element 441 and the first surface 4421.

The first thermoelectric conversion element 443 is thermally coupled to the second surface 4422, and transports the heat with the first base 442. Specifically, the first thermoelectric conversion element 443 is formed of a Peltier element, and absorbs the heat of the wavelength conversion element 441 from the first base 442 in accordance with the electric power to be supplied by the control unit 7. Further, it is possible for the first thermoelectric conversion element 443 to warm the wavelength conversion element 441 via the first base 442 in accordance with the electric power input thereto by reversing the polarity.

In other words, an operation of the first thermoelectric conversion device 443 is controlled by the control unit 7.

The first temperature sensor 444 detects the temperature of the wavelength conversion element 441, and then outputs the temperature thus detected to the control unit 7. The first temperature sensor 444 is disposed on the first base 442 so as to have contact with, for example, the wavelength conversion element 441.

Such a wavelength conversion device 44 is arranged in the heat receiving member 47 so that the surface at the opposite side to the first base 442 in the first thermoelectric conversion element 443 has contact with the heat receiving member 47.

### Configuration of Second Light Source

The second light source 45 is arranged side by side with the wavelength conversion device 44, and emits the red light toward the second color combining element 46. The second light source 45 is provided with at least one second light emitting element 451, a second base 452, a second thermoelectric conversion element 453, and the second temperature sensor 454.

The second light emitting element 451 outputs the red light RL. Specifically, the second light emitting element 451 is a semiconductor laser for outputting a red laser beam having a peak wavelength of, for example, 640 nm.

It should be noted that it is possible to dispose a transmissive diffuser plate between the second light emitting element 451 and the second color combining element 46, the transmissive diffuser plate diffusing the light entering the transmissive diffuser plate from the second light emitting element 451 and then making the result enter the second color combining element 46.

The second base 452 has a first surface 4521, and a second surface 4522 at an opposite side to the first surface 4521. The first surface 4521 corresponds to a third surface in the present disclosure, and the second surface 4522 corresponds to a fourth surface in the present disclosure.

The second base 452 supports the second light emitting element 451 with the first surface 4521. The second base 452 is formed of, for example, metal, and has thermal conductivity. Therefore, the second base 452 releases the heat, which is transferred from the second light emitting element 451, from the second surface 4522.

The second thermoelectric conversion element 453 is thermally coupled to the second surface 4522, and transports the heat with the second base 452. Specifically, the second thermoelectric conversion element 453 is formed of a Peltier element, and absorbs the heat of the second light emitting element 451 from the second base 452 in accordance with the electric power to be supplied by the control unit 7. Further, it is possible for the second thermoelectric conversion element 453 to warm the second light emitting element 451 via the second base 452 in accordance with the electric power input thereto by reversing the polarity.

In other words, an operation of the second thermoelectric conversion device 453 is controlled by the control unit 7.

The second temperature sensor 454 detects the temperature of the second light emitting element 451, and then outputs the temperature thus detected to the control unit 7. The second temperature sensor 454 is disposed on the second base 452 so as to have contact with, for example, the second light emitting element 451.

Such a second light source 45 is arranged in the heat receiving member 47 so that the surface at the opposite side to the second base 452 in the second thermoelectric conversion element 453 has contact with the heat receiving member 47.

### Configuration of Second Color Combining Element

The second color combining element 46 combines the red light RL emitted from the second light source 45 with the blue light BL1 having been transmitted through the first color combining element 42, and the wavelength-converted light YL reflected by the first color combining element 42. Specifically, the second color combining element 46 transmits the blue light BL1 and the wavelength-converted light YL, and reflects the red light RL in a direction in which the blue light BL1 and the wavelength-converted light YL are transmitted through the second color combining element 46. Thus, the blue light BL1, the wavelength-converted light YL, and the red light RL are combined with each other.

The blue light BL1, the wavelength-converted light YL, and the red light RL combined with each other by such a second color combining element 46 constitute illumination light WL having a white color to be emitted from the light source device 4.

### Configuration of Heat Receiving Member

The heat receiving member 47 is a substrate which supports the wavelength conversion device 44 and the second light source 45, and at the same time, receives the heat from the wavelength conversion device 44 and the second light source 45. The heat receiving member 47 can be said to be a single heat receiving member obtained by integrating the first heat receiving member for supporting the wavelength conversion device 44 and the second heat receiving member for supporting the second light source 45 with each other.

The heat receiving member 47 has a placement surface 471 and a radiation surface 472.

On the placement surface 471, there are arranged the wavelength conversion device 44 and the second light source 45. Specifically, on the placement surface 471, there is arranged the wavelength conversion device 44 so that the second surface 4432 of the first thermoelectric conversion element 443 has contact with the placement surface 471, and further, there is arranged the second light source 45 so that the second surface 4532 of the second thermoelectric conversion element 453 has contact with the placement surface 471.

The radiation surface 472 is a surface at an opposite side to the placement surface 471 in the heat receiving member 47. On the radiation surface 472, there is arranged the radiation member 48 so as to correspond to arrangement positions of the wavelength conversion device 44 and the second light source 45 in the placement surface 471.

Such a heat receiving member 47 is formed of a vapor chamber high in thermal diffusion efficiency. However, this is not a limitation, and the heat receiving member 47 can be a metal member good in thermal conductivity.

It should be noted that when the light source device 4 is provided with a chassis for housing the first light source 41, the first color combining element 42, the diffuse reflective element 43, the wavelength conversion device 44, the second light source 45, and the second color combining element 46, the heat receiving member 47 can be used as a closing member for closing the chassis. In this case, it is possible to arrange the radiation member 48 to which each of the heat of the wavelength conversion element 441 and the heat of the second light emitting element 451 is transferred via the heat receiving member 47 outside the chassis.

### Configuration of Radiation Member and Fan

The radiation member 48 is arranged on the radiation surface 472 of the heat receiving member 47. The radiation member 48 is arranged at an opposite side to the first base 442 with respect to the first thermoelectric conversion element 443, and at an opposite side to the second base 452 with respect to the second thermoelectric conversion element 453, and is thermally coupled to the first thermoelectric conversion element 443 and the second thermoelectric conversion element 453 via the heat receiving member 47.

The radiation member 48 releases the heat of each of the wavelength conversion device 44 and the second light source 45 transferred via the heat receiving member 47. In the detailed description, the radiation member 48 releases the heat of the wavelength conversion element 441 transferred via the first base 442, the first thermoelectric conversion element 443, and the heat receiving member 47, and the heat of the second light emitting element 451 transferred via the second base 452, the second thermoelectric conversion element 453, and the heat receiving member 47. In other words, the radiation member 48 can be said to be a radiation member having a first radiation member for releasing the heat of the wavelength conversion device 44 and a second radiation member for releasing the heat of the second light source 45 integrated with each other.

Such a radiation member 48 is formed of a heatsink which has a plurality of fins 481, and which releases the heat transferred from the heat receiving member 47 from the plurality of fins 481.

The fan 49 suctions a gas in the exterior housing 2 to circulate airflow through the radiation member 48. Thus, the radiation by the radiation member 48 is facilitated.

### Configuration of Light Intensity Detection Unit

The light intensity detection unit 6 shown in FIG. 1 detects the light intensity of the light emitted from the light source device 4. The light intensity detection unit 6 has a first light intensity sensor 61 and a second light intensity sensor 62.

The first light intensity sensor 61 detects the light intensity of the blue light BL1 obtained by the dichroic mirror 321 performing color separation on the illumination light WL emitted from the light source device 4. In the present embodiment, the first light intensity sensor 61 is disposed at an opposite side to the incident side of the blue light to the reflecting mirror 323, and detects the light intensity of the blue light leaked from the reflecting mirror 323. The first light intensity sensor 61 outputs the light intensity of the blue light thus detected to the control unit 7.

The second light intensity sensor 62 detects the light intensity of the red light RL obtained by the dichroic mirror 322 performing color separation on the illumination light WL emitted from the light source device 4. In the present embodiment, the second light intensity sensor 62 is disposed at an opposite side to the incident side of the red light to the reflecting mirror 334, and detects the light intensity of the red light leaked from the reflecting mirror 334. The second light intensity sensor 62 outputs the light intensity of the red light thus detected to the control unit 7. Configuration of Control Unit

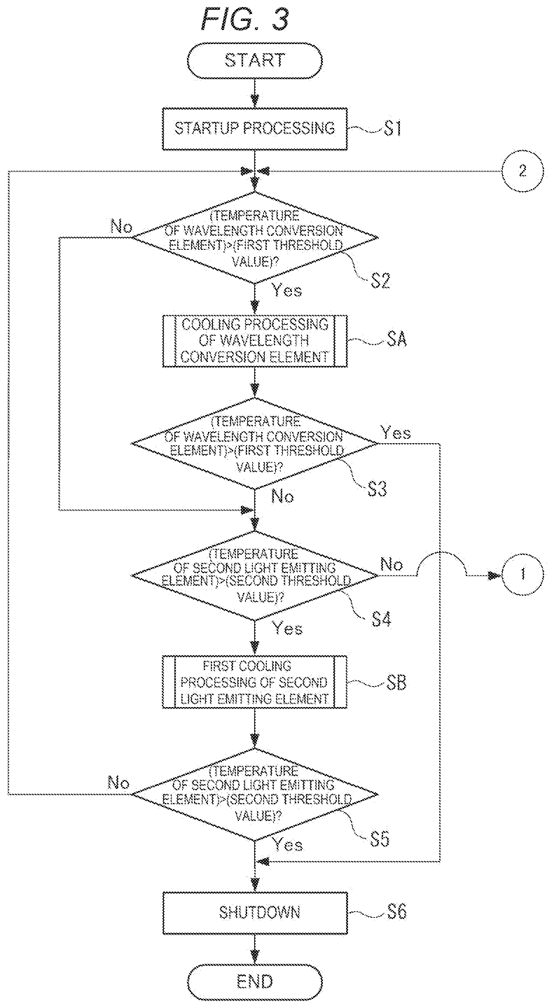

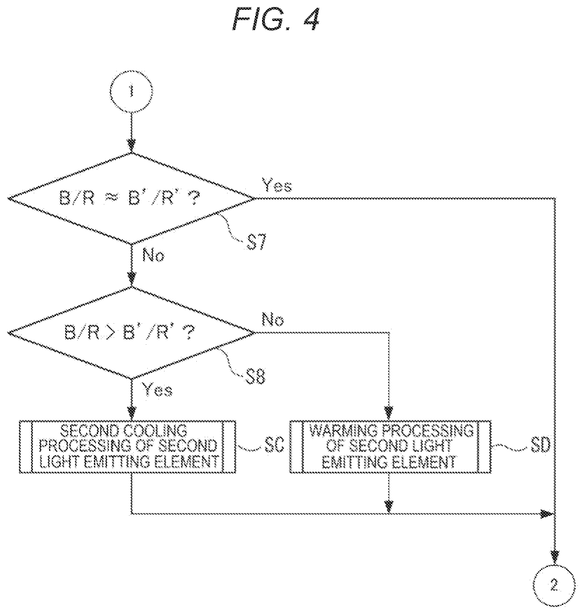

FIG. 3 and FIG. 4 are each a flowchart representing control processing performed by the control unit 7.

The control unit 7 executes the control processing shown in, for example, FIG. 3 and FIG. 4 to control the operation of the projector 1. The control processing includes light source control processing in the present disclosure. In other words, the control unit 7 constitutes a controller in the present disclosure, and the light source device and the control unit 7 constitute a light source control device LSC provided to the projector 1.

In the control processing, as shown in FIG. 3, the control unit 7 executes (step S1) startup processing of starting up the projector 1 due to power-on. In the startup processing, the control unit 7 puts the light source device 4 on, and in addition, drives the fan 49 for circulating the airflow through, for example, the wavelength conversion device 44 and the second light source 45 in an initial state. The output of the fan 49 in the initial state is set to, for example, 60% of the maximum output of the fan 49. When defining the output of the fan 49 due to PWM (Pulse Width Modulation) control, the control unit 7 sets a drive duty ratio of the fan 49 to 60%.

After the step S1, the control unit 7 determines (step S2) whether or not the temperature of the wavelength conversion element 441 detected by the first temperature sensor 444 has exceeded a first threshold value set in advance.

When it is determined in determination processing in the step S2 that the temperature of the wavelength conversion element 441 has not exceeded the first threshold value (No in the step S2), the control unit 7 makes the transition of the processing to the step S4.

When it is determined in the determination processing in the step S2 that the temperature of the wavelength conversion element 441 has exceeded the first threshold value (Yes in the step S2), the control unit 7 executes cooling processing SA of the wavelength conversion element 441.

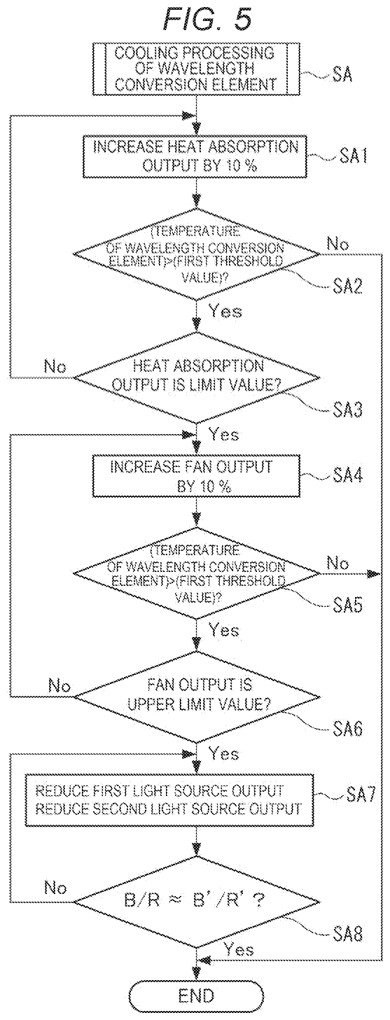

FIG. 5 is a flowchart showing the cooling processing SA of the wavelength conversion element 441.

In the cooling processing SA of the wavelength conversion element 441, cooling of the wavelength conversion element 441 by the first thermoelectric conversion element 443 is performed in priority to cooling of the wavelength conversion element 441 by the fan 49.

Specifically, in the cooling processing SA, the control unit 7 first increases (step SA1) a heat absorption output of the first thermoelectric conversion element 443 by 10%.

Subsequently, the control unit 7 determines (step SA2) whether or not the temperature of the wavelength conversion element 441 has exceeded the first threshold value.

When it is determined in the determination processing in the step SA2 that the temperature of the wavelength conversion element 441 has not exceeded the first threshold value (No in the step SA2), the control unit 7 terminates the cooling processing SA.

When it is determined in the determination processing in the step SA2 that the temperature of the wavelength conversion element 441 has exceeded the first threshold value (Yes in the step SA2), the control unit 7 determines (step SA3) whether or not the current heat absorption output of the first thermoelectric conversion element 443 has reached a limit value.

It should be noted that the limit value of the heat absorption output of the first thermoelectric conversion element 443 can be a maximum value of the heat absorption output of the first thermoelectric conversion element 443, or can also be a maximum output value in a range in which an increase rate of the heat absorption output corresponding to the supply power does not decrease to a level lower than a predetermined value. In the present embodiment, the limit value of the heat absorption output of the first thermoelectric conversion element 443 is set to the output value when supplying the electric power 50% as high as a maximum allowable power when absorbing the heat taking a drive efficiency of the first thermoelectric conversion element 443 into consideration.

When it is determined in determination processing in the step SA3 that the heat absorption output of the first thermoelectric conversion element 443 has not reached the limit value (No in the step SA3), the control unit 7 returns the processing to the step SA1 to execute the step SA1 once again. Thus, the heat absorption output of the first thermoelectric conversion element 443 further increases by 10%. As described above, the steps SA1 through SA3 are processing related to cooling control of the wavelength conversion element 441 by the first thermoelectric conversion element 443, and the control unit 7 executes the steps SA1 through SA3 to increase the heat absorption output to the wavelength conversion element 441 by the first thermoelectric conversion element 443 in a stepwise manner.

When it is determined in the determination processing in the step SA3 that the heat absorption output of the first thermoelectric conversion element 443 has reached the limit value (Yes in the step SA3), the control unit 7 increases (step SA4) the output of the fan 49 by 10%.

After the step SA4, the control unit 7 determines (step SA5) whether or not the temperature of the wavelength conversion element 441 has exceeded the first threshold value.

When it is determined in determination processing in the step SA5 that the temperature of the wavelength conversion element 441 has not exceeded the first threshold value (No in the step SA5), the control unit 7 terminates the cooling processing SA.

When it is determined in the determination processing in the step SA5 that the temperature of the wavelength conversion element 441 has exceeded the first threshold value (Yes in the step SA5), the control unit 7 determines (step SA6) whether or not the current output of the fan 49 has reached 100% as the upper limit value. It should be noted that the upper limit value is not required to be 100%.

When it is determined in determination processing in the step SA6 that the output of the fan 49 has not reached the upper limit value (No in the step SA6), the control unit 7 returns the processing to the step SA4 to execute the step SA4 once again. Thus, the output of the fan 49 further increases by 10%. As described above, the steps SA4 through SA6 are processing related to output raising control of the fan 49, and the control unit 7 executes the steps SA4 through SA6 to increase the output of the fan 49 in a stepwise manner.

When it is determined in the determination processing in the step SA6 that the output of the fan 49 has reached the upper limit value (Yes in the step SA6), the control unit 7 reduces the output of the blue light by the first light source 41, and at the same time, reduces the output of the red light by the second light source 45 (Step SA7). Thus, the temperature of the wavelength conversion element 441 lowers, and in addition, the white balance of the illumination light is prevented from being dramatically lost.

After the step SA7, the control unit 7 determines (step SA8) whether or not a ratio B/R of the light intensity of the blue light BL1 included in the illumination light WL to the light intensity of the red light RL included in the illumination light WL is included in a reference range set in advance based on the detection result of the first light intensity sensor 61 and the second light intensity sensor 62. For example, the control unit 7 determines whether or not the ratio B/R is included in a range no lower than 95% and no higher than 105% of a reference value B′/R′. It should be noted that the ratio B/R represents the white balance of the illumination light WL.

When it is determined in determination processing in the step SA8 that the ratio B/R is not included in the reference range, the control unit 7 returns the processing to the step SA7. As described above, the steps SA7, SA8 are repeatedly executed until it is determined by the control unit 7 that the ratio B/R is included in the reference range. Thus, the white balance of the illumination light WL is maintained within the reference range.

When it is determined in the determination processing in the step SA8 that the ratio B/R is included in the reference range, the control unit 7 terminates the cooling processing SA to make the transition of the processing to the step S3.

In the step S3, the control unit 7 determines (step S3) whether or not the temperature of the wavelength conversion element 441 has exceeded the first threshold value after the cooling processing SA.

When it is determined in determination processing in the step S3 that the temperature of the wavelength conversion element 441 has exceeded the first threshold value (Yes in the step S3), the control unit 7 makes the transition of the processing to the step S6 to execute shutdown processing described later.

When it is determined in the determination processing in the step S3 that the temperature of the wavelength conversion element 441 has not proceeded the first threshold value (No in the step S3), the control unit 7 determines (step S4) whether or not the temperature of the second light emitting element 451 detected by the second temperature sensor 454 has exceeded a second threshold value set in advance while keeping the drive state of the fan 49.

When it is determined in determination processing in the step S4 that the temperature of the second light emitting element 451 has exceeded the second threshold value (Yes in the step S4), the control unit 7 executes a first cooling processing SB of the second light emitting element 451.

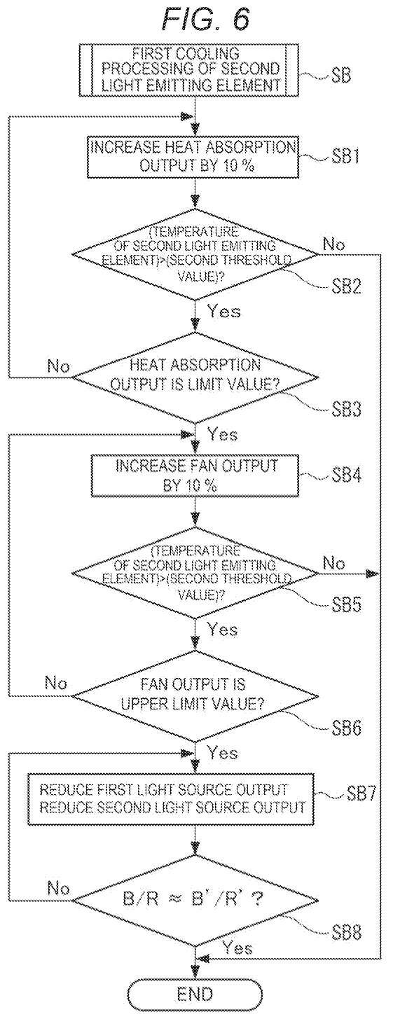

FIG. 6 is a flowchart showing the first cooling processing SB of the second light emitting element 451.

In the first cooling processing SB of the second light emitting element 451, cooling of the second light emitting element 451 by the second thermoelectric conversion element 453 is performed in priority to cooling of the second light emitting element 451 by the fan 49.

Specifically, in the first cooling processing SB, the control unit 7 first increases (step SB1) a heat absorption output of the second thermoelectric conversion element 453 by 10%.

Subsequently, the control unit 7 determines (step SB2) whether or not the temperature of the second light emitting element 451 has exceeded the second threshold value.

When it is determined in determination processing in the step SB2 that the temperature of the second light emitting element 451 has not exceeded the second threshold value (No in the step SB2), the control unit 7 terminates the first cooling processing SB.

When it is determined in the determination processing in the step SB2 that the temperature of the second light emitting element 451 has exceeded the second threshold value (Yes in the step SB2), the control unit 7 determines (step SB3) whether or not the current heat absorption output of the second thermoelectric conversion element 453 has reached a limit value.

It should be noted that the limit value of the heat absorption output of the second thermoelectric conversion element 453 can be a maximum value of the heat absorption output of the second thermoelectric conversion element 453, or can also be a maximum output value in a range in which an increase rate of the heat absorption output corresponding to the supply power does not decrease to a level lower than a predetermined value. In the present embodiment, the limit value of the heat absorption output of the second thermoelectric conversion element 453 is set to the output value when supplying the electric power 50% as high as a maximum allowable power when absorbing the heat taking a drive efficiency of the second thermoelectric conversion element 453 into consideration.

When it is determined in determination processing in the step SB3 that the heat absorption output of the second thermoelectric conversion element 453 has not reached the limit value (No in the step SB3), the control unit 7 returns the processing to the step SB1 to execute the step SB1 once again. Thus, the heat absorption output of the second thermoelectric conversion element 453 further increases by 10%. As described above, the steps SB1 through SB3 are processing related to cooling control of the second light emitting element 451 by the second thermoelectric conversion element 453, and the control unit 7 executes the steps SB1 through SB3 to increase the heat absorption output to the second light emitting element 451 by the second thermoelectric conversion element 453 in a stepwise manner.

When it is determined in the determination processing in the step SB3 that the heat absorption output of the second thermoelectric conversion element 453 has reached the limit value (Yes in the step SB3), the control unit 7 increases (step SB4) the output of the fan 49 by 10%.

After the step SB4, the control unit 7 determines (step SB5) whether or not the temperature of the second light emitting element 451 has exceeded the second threshold value.

When it is determined in determination processing in the step SB5 that the temperature of the second light emitting element 451 has not exceeded the second threshold value (No in the step SB5), the control unit 7 terminates the first cooling processing SB.

When it is determined in the determination processing in the step SB5 that the temperature of the second light emitting element 451 has exceeded the second threshold value (Yes in the step SB5), the control unit 7 determines (step SB6) whether or not the current output of the fan 49 has reached 100% as the upper limit value. It should be noted that the upper limit value is not required to be 100%.

When it is determined in determination processing in the step SB6 that the output of the fan 49 has not reached the upper limit value (No in the step SB6), the control unit 7 returns the processing to the step SB4 to execute the step SB4 once again. Thus, the output of the fan 49 further increases by 10%. As described above, the steps SB4 through SB6 are processing related to the output raising control of the fan 49, and the control unit 7 executes the steps SB4 through SB6 to increase the output of the fan 49 in a stepwise manner.

When it is determined in the determination processing in the step SB6 that the output of the fan 49 has reached the upper limit value (Yes in the step SB6), the control unit 7 reduces the output of the red light by the second light source 45, and at the same time, reduces the output of the blue light by the first light source 41 (Step SB7). Thus, the temperature of the second light emitting element 451 lowers, and in addition, the white balance of the illumination light is prevented from being dramatically lost.

After the step SB7, the control unit 7 determines (step SB8) whether or not the ratio B/R described above is included in the reference range described above based on the detection result by the first light intensity sensor 61 and the second light intensity sensor 62 similarly to the step SA8.

When it is determined in determination processing in the step SB8 that the ratio B/R is not included in the reference range, the control unit 7 returns the processing to the step SB7. As described above, the steps SB7, SB8 are repeatedly executed until it is determined by the control unit 7 that the ratio B/R is included in the reference range. Thus, the white balance of the illumination light WL is maintained within the reference range.

When it is determined in the determination processing in the step SB8 that the ratio B/R is included in the reference range, the control unit 7 terminates the first cooling processing SB to make the transition of the processing to the step S5.

In the step S5, the control unit 7 determines (step S5) whether or not the temperature of the second light emitting element 451 detected by the second temperature sensor 454 has exceeded the second threshold value while keeping the drive state of the fan 49.

When it is determined in determination processing in the step S5 that the temperature of the second light emitting element 451 has not exceeded the second threshold value (No in the step S5), the control unit 7 returns the processing to the step S1. Thus, temperature control of the wavelength conversion element 441 and the second light emitting element 451 is performed once again.

When it is determined in the determination processing in the step S5 that the temperature of the second light emitting element 451 has exceeded the second threshold value (Yes in the step S5), the control unit 7 makes the transition of the processing to the step S6.

In the step S6, the control unit 7 executes (step S6) the shutdown processing of the projector 1. For example, the control unit 7 informs the user of the reason of the shutdown, and at the same time, stops the drive of the thermoelectric conversion elements 443, 453 and the fan 49.

Due to such shutdown processing as described above, the control unit 7 terminates the light source control processing.

On the other hand, when it is determined in determination processing in the step S4 that the temperature of the second light emitting element 451 has not exceeded the second threshold value (No in the step S4), the control unit 7 determines (step S7) whether or not the ratio B/R is included in the reference range described above as shown in FIG. 4.

When it is determined in determination processing in the step S7 that the ratio B/R is included in the reference range described above (Yes in the step S7), the control unit 7 returns the processing to the step S2 as shown in FIG. 3.

When it is determined in the determination processing in the step S7 that the ratio B/R is not included in the reference range described above (No in the step S7), the control unit 7 determines (step S8) whether or not the ratio B/R has exceeded the upper limit value of the reference range described above.

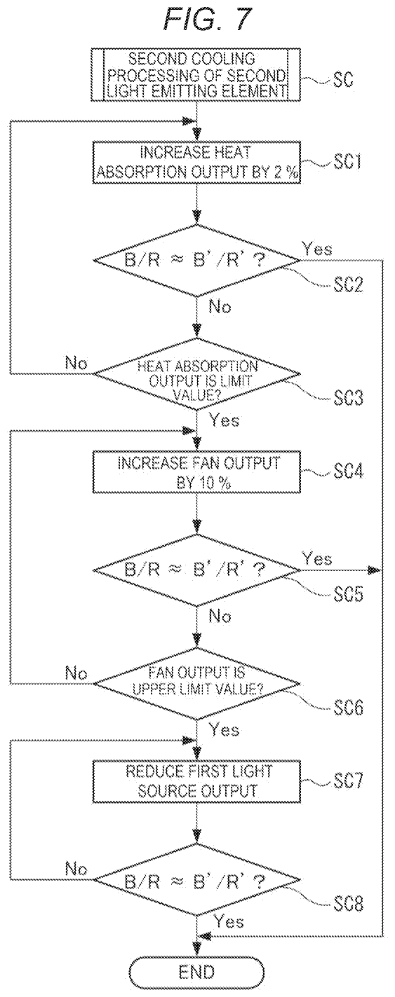

FIG. 7 is a flowchart showing second cooling processing SC of the second light emitting element 451.

When it is determined in determination processing in the step S8 that the ratio B/R has exceeded the upper limit value of the reference range described above (Yes in the step S8), the control unit 7 executes the second cooling processing SC of the second light emitting element 451 shown in FIG. 7 in order to lower the ratio B/R. In other words, the second cooling processing SC is control processing of the white balance of the illumination light WL due to the cooling.

In the second cooling processing SC of the second light emitting element 451, cooling of the second light emitting element 451 by the second thermoelectric conversion element 453 is performed in priority to cooling of the second light emitting element 451 by the second thermoelectric conversion element 453 to lower the ratio B/R.

Specifically, in the second cooling processing SC, the control unit 7 first increases (step SC1) the heat absorption output of the second thermoelectric conversion element 453 by 2%.

Subsequently, the control unit 7 determines (step SC2) whether or not the ratio B/R is included in the reference range.

When it is determined in determination processing in the step SC2 that the ratio B/R is included in the reference range (Yes in the step SC2), the control unit 7 terminates the second cooling processing SC.

When it is determined in the determination processing in the step SC2 that the ratio B/R is not included in the reference range (No in the step SC2), the control unit 7 determines (step SC3) whether or not the current heat absorption output of the second thermoelectric conversion element 453 has reached the limit value.

When it is determined in determination processing in the step SC3 that the heat absorption output of the second thermoelectric conversion element 453 has not reached the limit value (No in the step SC3), the control unit 7 returns the processing to the step SC1 to execute the step SC1 once again. Thus, the heat absorption output of the second thermoelectric conversion element 453 further increases by 2%. As described above, the control unit 7 executes the steps SC1 through SC3 to gradually raise the heat absorption output to the second light emitting element 451 by the second thermoelectric conversion element 453.

When it is determined in the determination processing in the step SC3 that the heat absorption output of the second thermoelectric conversion element 453 has reached the limit value (Yes in the step SC3), the control unit 7 increases (step SC4) the output of the fan 49 by 10%.

After the step SC4, the control unit 7 determines (step SC5) whether or not the ratio B/R is included in the reference range.

When it is determined in determination processing in the step SC5 that the ratio B/R is included in the reference range (Yes in the step SC5), the control unit 7 terminates the second cooling processing SC.

When it is determined in the determination processing in the step SC5 that the ratio B/R is not included in the reference range (No in the step SC5), the control unit 7 determines (step SC6) whether or not the current output of the fan 49 has reached 100% as an output upper limit value. It should be noted that the output upper limit value is not required to be 100%.

When it is determined in determination processing in the step SC6 that the output of the fan 49 has not reached the upper limit value (No in the step SC6), the control unit 7 returns the processing to the step SC4 to execute the step SC4 once again. Thus, the output of the fan 49 further increases by 10%.

As described above, the control unit 7 executes the steps SC4 through SC6 to gradually raise the output of the fan 49.

When it is determined in the determination processing in the step SC6 that the output of the fan 49 has reached the upper limit value (Yes in the step SC6), the control unit 7 reduces the supply power to the first light emitting element 411 to reduce the output of the blue light by the first light source 41 (step SC7). In other words, in the step SC7, the output of the first light emitting element 411 is reduced.

It should be noted that in the step SC7, it is possible to warm the first light emitting element 411 with a thermoelectric conversion element thermally coupled to the first light emitting element 411 instead of, or in addition to, the reduction of the supply power to the first light emitting element 411. However, the responsivity of the first light emitting element 411 for emitting the blue light is not better than the responsivity of the second light emitting element 451 for emitting the red light, and in addition, the life of the first light emitting element 411 is shortened by warming in some cases. Therefore, in the step SC7, it is preferable to reduce the output of the blue light by the first light source 41 by reducing the supply power to the first light emitting element 411.

On the other hand, in the step SC7, it is possible to reduce the output of the red light by reducing the supply power to the second light emitting element 451, and thus, reduce the output of the second light emitting element 451 while keeping the temperature of the second light emitting element 451 no higher than the second threshold value. In this case, it is possible to actively lower the temperature of the second light emitting element 451.

Further, in the step SC7, it is possible to perform at least either one of the reduction in supply power to the first light emitting element 411 and the warming of the first light emitting element 411, and the reduction in supply power to the second light emitting element 451 in combination.

After the step SC7, the control unit 7 determines (step SC8) whether or not the ratio B/R is included in the reference range.

When it is determined in determination processing in the step SC8 that the ratio B/R is not included in the reference range, the control unit 7 returns the processing to the step SC7. As described above, the steps SC7, SC8 are repeatedly executed until it is determined by the control unit 7 that the ratio B/R is included in the reference range.

When it is determined in the determination processing in the step SC8 that the ratio B/R is included in the reference range, the control unit 7 terminates the second cooling processing SC of the second light emitting element 451.

The control unit 7 executes the second cooling processing SC as shown in FIG. 4, and then returns the processing to the step S2 shown in FIG. 3.

On the other hand, when it is determined in determination processing in the step S8 that the ratio B/R has not exceeded the upper limit value of the reference range described above (No in the step S8), the control unit 7 executes warming processing SD of the second light emitting element 451 in order to increase the ratio B/R. In other words, when it is determined that the ratio B/R is lower than a lower limit value of the reference range, the control unit 7 executes the warming processing SD of the second light emitting element 451. Therefore, the warming processing SD is control processing of the white balance of the illumination light WL due to warming.

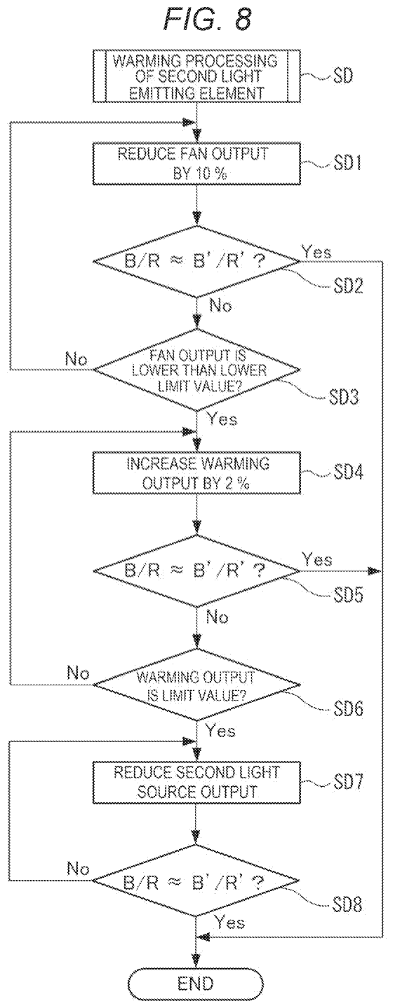

FIG. 8 is a flowchart representing the warming processing SD of the second light emitting element 451.

In warming processing SD of the second light emitting element 451, warming of the second light emitting element 451 by the output reduction of the fan 49 is performed in priority to warming of the second light emitting element 451 by the second thermoelectric conversion element 453 to achieve an increase in the ratio B/R.

Specifically, in the warming processing SD of the second light emitting element 451, the control unit 7 first reduces (step SD1) the output of the fan 49 by 10%.

After the step SD1, the control unit 7 determines (step SD2) whether or not the ratio B/R is included in the reference range described above.

When it is determined in determination processing in the step SD2 that the ratio B/R is included in the reference range (Yes in the step SD2), the control unit 7 terminates the warming processing SD, and then returns the processing to the step S2 as shown in FIG. 3 and FIG. 4.

When it is determined in the determination processing in the step SD2 that the ratio B/R is not included in the reference range (No in the step SD2), the control unit 7 determines (step SD3) whether or not the current output of the fan 49 is lower than 20% as the lower limit value. It should be noted that the lower limit value is not required to be 20%.

When it is determined in determination processing in the step SD3 that the output of the fan 49 is not lower than the lower limit value (No in the step SD3), the control unit 7 returns the processing to the step SD1 to execute the step SD1 once again. Thus, the output of the fan 49 further reduces by 10%. As described above, the steps SD1 through SD3 are processing related to the output reduction control of the fan 49, and the control unit 7 executes the steps SD1 through SD3 to reduce the output of the fan 49 in a stepwise manner.

When it is determined in the determination processing in the step SD3 that the output of the fan 49 is lower than the lower limit value (Yes in the step SD3), the control unit 7 increases (step SD4) a warming output of the second thermoelectric conversion element 453 by 2%. On this occasion, the control unit 7 reverses the polarity of the second thermoelectric conversion element 453 as the Peltier element between the cooling processing SA, SB and the warming processing SD.

After the step SD4, the control unit 7 determines (step SD5) whether or not the ratio B/R is included in the reference range.

When it is determined in determination processing in the step SD5 that the ratio B/R is included in the reference range (Yes in the step SD5), the control unit 7 terminates the warming processing SD, and then returns the processing to the step S2 as shown in FIG. 3 and FIG. 4.

When it is determined in the determination processing in the step SD5 that the ratio B/R is not included in the reference range (No in the step SD5), the control unit 7 determines (step SD6) whether or not the warming output of the second thermoelectric conversion element 453 has reached the limit value.

It should be noted that the limit value of the warming output of the second thermoelectric conversion element 453 can be a maximum value of the warming output of the second thermoelectric conversion element 453, or can also be a maximum output value in a range in which an increase rate of the warming output corresponding to the supply power does not decrease to a level lower than a predetermined value. In the present embodiment, the limit value of the warming output of the second thermoelectric conversion element 453 is set to the output value when supplying the electric power 50% as high as a maximum allowable power when performing the warming taking a drive efficiency of the second thermoelectric conversion element 453 into consideration.

When it is determined in determination processing in the step SD6 that the warming output of the second thermoelectric conversion element 453 has not reached the limit value (No in the step SD6), the control unit 7 returns the processing to the step SD4 to execute the step SD4 once again. Thus, the warming output of the second thermoelectric conversion element 453 further increases by 2%. As described above, the steps SD4 through SD6 are processing related to warming control of the second light emitting element 451 by the second thermoelectric conversion element 453, and the control unit 7 executes the steps SD4 through SD6 to gradually raise the warming output to the second light emitting element 451 by the second thermoelectric conversion element 453.

When it is determined in the determination processing in the step SD6 that the warming output of the second thermoelectric conversion element 453 has reached the limit value (Yes in the step SD6), the control unit 7 reduces the supply power to the second light emitting element 451 to thereby reduce the output of the red light by the second light source 45 (step SD7). In other words, in the step SD7, the output of the second light emitting element 451 is reduced.

It should be noted that in the step SD7, it is possible to increase the output of the blue light by the first light source 41 by increasing the supply power to the first light emitting element 411 instead of, or in addition to, the reduction of the supply power to the second light emitting element 451.

Further, as described above, the responsivity of the first light emitting element 411 for outputting the blue light is not better than the responsivity of the second light emitting element 451 for outputting the red light, and an output change corresponding to the supply power to the first light emitting element 411 is smaller than an output change corresponding to the supply power to the second light emitting element 451. Therefore, it is possible to perform at least either one of the reduction in supply power to the second light emitting element 451 and the warming of the second light emitting element 451, and the increase in supply power to the first light emitting element 411 in combination.

After the step SD7, the control unit 7 determines (step SD8) whether or not the ratio B/R is included in the reference range.

When it is determined in determination processing in the step SD8 that the ratio B/R is not included in the reference range, the control unit 7 returns the processing to the step SD7. As described above, the steps SD7, SD8 are repeatedly executed until it is determined by the control unit 7 that the ratio B/R is included in the reference range.

When it is determined in the determination processing in the step SD8 that the ratio B/R is included in the reference range, the control unit 7 terminates the warming processing SD of the second light emitting element 451.

The control unit 7 executes the warming processing SD as shown in FIG. 4, and then returns the processing to the step S2 shown in FIG. 3.

As described above, during the power of the projector 1 is kept ON, the control unit 7 repeatedly executes the processing in the step S2 and the steps following the step S2 in the control processing described above unless it is determined in the step S3 that the temperature of the wavelength conversion element 441 has exceeded the first threshold value, or it is determined in the step S5 that the temperature of the second light emitting element 451 has exceeded the second threshold value, and thus, the projector 1 is shut down in the step S6.

Thus, it is possible to maintain the white balance of the illumination light WL emitted from the light source device 4.

### Advantages of First Embodiment

The projector 1 according to the present embodiment described hereinabove exerts the following advantages.

The projector 1 is provided with the light source control device LSC having the light source device 4 and the control unit 7, the image forming device 34, and the projection optical device 36. The image forming device 34 forms the image light from the light emitted from the light source device 4 of the light source control device LSC. The projection optical device 36 projects the image light formed by the image forming device 34.

The light source control device LSC outputs the illumination light WL. The light source control device LSC is provided with the first light emitting element 411, the wavelength conversion element 441, the first thermoelectric conversion element 443, the second light emitting element 451, the second thermoelectric conversion element 453, the radiation member 48, and the control unit 7.

The first light emitting element 411 outputs the blue light, and the second light emitting element 451 outputs the red light.

The wavelength conversion element 441 converts the blue light BL2 entering the wavelength conversion element 441 into the wavelength-converted light YL.

The first thermoelectric conversion element 443 is thermally coupled to the wavelength conversion element 441.

The second thermoelectric conversion element 453 is thermally coupled to the second light emitting element 451.

The radiation member 48 is thermally coupled to the first thermoelectric conversion element 443, and in addition, thermally coupled to the second thermoelectric conversion element 453.

The control unit 7 controls the drive of each of the first thermoelectric conversion element 443 and the second thermoelectric conversion element 453. The control unit 7 corresponds to the controller.

According to such a configuration, it is possible to control the temperature of the wavelength conversion element 441 and the temperature of the second light emitting element 451 by the control unit 7 controlling the first thermoelectric conversion element 443 and the second thermoelectric conversion element 453. Thus, it is possible to maintain the wavelength conversion efficiency of the wavelength conversion element 441, and in addition, it is possible to stabilize the output of the red light by the second light emitting element 451. Therefore, it is possible to adjust the white balance of the illumination light output from the light source control device LSC, and it is possible to project the image light formed based on the illumination light good in white balance.

In the light source control device LSC, the control unit 7 performs the cooling of the wavelength conversion element 441 by the first thermoelectric conversion element 443 in priority to the cooling of the second light emitting element 451 by the second thermoelectric conversion element 453 in the control processing.

According to such a configuration, since the conversion efficiency into the wavelength-converted light YL can be maintained, it is possible to prevent the white balance from being dramatically lost. Further, by cooling the wavelength conversion element 441 in priority to the second light emitting element 451, it is possible to prevent the deterioration and the breakage of the wavelength conversion element 441.

The light source control device LSC is provided with the fan 49 for circulating the airflow through the radiation member 48.

The control unit 7 controls the drive of the fan 49.

According to such a configuration, it is possible to increase the radiation efficiency by the radiation member 48 by the fan 49 circulating the airflow through the radiation member 48. Therefore, it is possible to increase the cooling efficiency of each of the wavelength conversion element 441 and the second light emitting element 451.

In the light source control device LSC, the control unit 7 performs the cooling of the wavelength conversion element 441 in the cooling processing SA with the first thermoelectric conversion element 443 in priority to the fan 49.

According to such a configuration, since the cooling with the first thermoelectric conversion element 443 higher in cooling efficiency than the fan 49 is performed in priority to the cooling with the fan 49 when cooling the wavelength conversion element 441, it is possible to promptly perform the cooling of the wavelength conversion element 441.

Further, when the wavelength conversion element 441 is sufficiently cooled by the first thermoelectric conversion element 443, there is no need to increase the output of the fan 49. In such a case, it is possible to prevent the sound noise of the fan 49 from increasing, and by extension, it is possible to achieve a reduction in sound noise of the light source control device LSC.

In the light source control device LSC, when the temperature of the wavelength conversion element 441 has exceeded the first threshold value after performing the cooling of the wavelength conversion element 441 with the first thermoelectric conversion element 443 and the cooling of the wavelength conversion element 441 with the fan 49, the control unit 7 reduces the output of each of the first light emitting element 411 and the second light emitting element 451. The first threshold value corresponds to a threshold value for the wavelength conversion element.

According to such a configuration, since the light intensity of the blue light input to the wavelength conversion element 441 reduces although the luminance of the light output from the light source control device LSC is reduced by reducing the output of the first light emitting element 411, it is possible to lower the temperature of the wavelength conversion element 441.

Further, by reducing not only the output of the first light emitting element 411, but also the output of the second light emitting element 451, it is possible to make it easy to maintain the white balance of the light output from the light source control device LSC.

In the light source control device LSC, the control unit 7 performs the cooling of the second light emitting element 451 with the second thermoelectric conversion element 453 in priority to the fan 49 in the first cooling processing SB and the second cooling processing SC of the second light emitting element 451.

According to such a configuration, since the cooling with the second thermoelectric conversion element 453 higher in cooling efficiency than the fan 49 is performed in priority to the cooling with the fan 49 when cooling the second light emitting element 451, it is possible to promptly perform the cooling of the second light emitting element 451.

Further, when the second light emitting element 451 is sufficiently cooled by the second thermoelectric conversion element 453, there is no need to increase the output of the fan 49. In such a case, it is possible to prevent the sound noise of the fan 49 from increasing, and by extension, it is possible to achieve a reduction in sound noise of the light source control device LSC.

In the light source control device LSC, when the temperature of the second light emitting element 451 has exceeded the second threshold value after performing the cooling of the second light emitting element 451 with the second thermoelectric conversion element 453 and the cooling of the second light emitting element 451 with the fan 49, the control unit 7 reduces the output of each of the first light emitting element 411 and the second light emitting element 451. The second threshold value corresponds to a threshold value for the second light emitting element.

According to such a configuration, since an amount of heat generated in the second light emitting element 451 reduces although the luminance of the light output from the light source control device LSC is reduced by reducing the output of the second light emitting element 451, it is possible to lower the temperature of the second light emitting element 451.

Further, by reducing not only the output of the second light emitting element 451, but also the output of the first light emitting element 411, it is possible to make it easy to maintain the white balance of the light output from the light source control device LSC.

In the light source control device LSC, the control unit 7 controls the ratio B/R of the light intensity of the blue light BL1 included in the illumination light WL to the light intensity of the red light RL included in the illumination light WL using the first thermoelectric conversion element 443, the second thermoelectric conversion element 453, and the fan 49.

According to such a configuration, since it is possible to control the temperature of the wavelength conversion element 441 using the first thermoelectric conversion element 443 and the fan 49, and it is possible to control the temperature of the second light emitting element 451 using the second thermoelectric conversion element 453 and the fan 49, it is possible to control the light intensity of each of the blue light BL1, the wavelength-converted light YL, and the red light RL output from the light source control device LSC. Therefore, it is possible to maintain the white balance of the illumination light WL output from the light source control device LSC.

In the light source control device LSC, when reducing the ratio B/R in the second cooling processing SC, the control unit 7 performs the cooling of the second light emitting element 451 using the second thermoelectric conversion element 453 and the fan 49.

According to such a configuration, by cooling the second light emitting element 451 with the second thermoelectric conversion element 453 and the fan 49, it is possible to increase the output of the red light RL by the second light emitting element 451. Therefore, it is possible to reduce the ratio B/R described above.

In the light source control device LSC, when the ratio B/R has not reached the upper limit value of the reference range described above after performing the cooling of the second light emitting element 451 with the second thermoelectric conversion element 453 and the cooling of the second light emitting element 451 with the fan 49, the control unit 7 reduces the supply power to the first light emitting element 411 to thereby reduce the output of the blue light by the first light emitting element 411. In other words, in the step SC7 in the second cooling processing SC, the control unit 7 reduces the output of the blue light by the first light emitting element 411.

Here, when the ratio B/R described above has not reached the upper limit value even after performing the cooling of the second light emitting element 451 with the second thermoelectric conversion element 453 and the fan 49, it is assumed that the output of the red light RL by the second light emitting element 451 has reduced. In such a case, it is possible to reduce the ratio B/R described above by the control unit 7 reducing the output of the blue light BL by the first light emitting element 411.

In the light source control device LSC, when raising the ratio B/R, the control unit 7 warms the second light emitting element 451 using the second thermoelectric conversion element 453 and the fan 49.

According to such a configuration, by warming the second light emitting element 451, it is possible to reduce the output of the red light RL by the second light emitting element 451. Thus, it is possible to raise the ratio B/R described above.

In the light source control device LSC, when the ratio B/R has not reached the lower limit value of the reference range described above after performing the warming of the second light emitting element 451 with the second thermoelectric conversion element 453 and the warming of the second light emitting element 451 with the fan 49, the control unit 7 reduces the supply power to the second light emitting element 451 to thereby reduce the output of the red light by the second light emitting element 451.

According to such a configuration, when the ratio B/R described above has not reached the lower limit value even after performing the warming of the second light emitting element 451 with the second thermoelectric conversion element 453 and the fan 49 when raising the ratio B/R described above, it is possible to reduce the light intensity of the red light RL output from the second light emitting element 451 by the control unit 7 reducing the output of the second light emitting element 451. Therefore, it is possible to raise the ratio B/R described above.

The projector 1 is provided with the light source device 4, the image forming device 34, and the projection optical device 36.

The image forming device 34 forms the image light from the light emitted from the light source device 4.

The projection optical device 36 projects the image light formed by the image forming device 34.

The light source device 4 is provided with the first light source 41, the first color combining element 42, the wavelength conversion device 44, the second light source 45, the second color combining element 46, and the radiation member 48.

The first light source 41 outputs the blue light BL including the blue light BL1 and the blue light BL2, and the second light source 45 outputs the red light RL.

The wavelength conversion device 44 converts the blue light BL2 entering the wavelength conversion device 44 into the wavelength-converted light YL.

The first color combining element 42 and the second color combining element 46 combine the blue light BL1, the wavelength-converted light YL, and the red light RL.

The wavelength conversion device 44 has the wavelength conversion element 441, the first base 442, and the first thermoelectric conversion element 443.

The wavelength conversion element 441 converts the blue light BL2 into the wavelength-converted light YL.

The first base 442 has the thermal conductivity, and in addition, has the first surface 4421, and the second surface 4422 at the opposite side to the first surface 4421. The first base 442 supports the wavelength conversion element 441 with the first surface 4421.

The first thermoelectric conversion element 443 is thermally coupled to the second surface 4422 of the first base 442.

The second light source 45 has the second light emitting element 451 as the light emitting element, the second base 452, and the second thermoelectric conversion element 453.

The second base 452 has the thermal conductivity, and in addition, has the first surface 4521, and the second surface 4522 at the opposite side to the first surface 4521. The first surface 4521 corresponds to the third surface, and the second surface 4522 corresponds to the fourth surface. The second base 452 supports the second light emitting element 451 with the first surface 4521.

The second thermoelectric conversion element 453 is thermally coupled to the second surface 4522 of the second base 452.

The radiation member 48 corresponds to the first radiation member and the second radiation member. The radiation member 48 is arranged at an opposite side to the first base 442 with respect to the first thermoelectric conversion element 443, and is thermally coupled to the first thermoelectric conversion element 443. Further, the radiation member 48 is arranged at an opposite side to the second base 452 with respect to the second thermoelectric conversion element 453, and is thermally coupled to the second thermoelectric conversion element 453.

According to such a configuration, it is possible to perform the temperature control of the wavelength conversion element 441 using the first thermoelectric conversion element 443 thermally coupled to the wavelength conversion element 441 via the first base 442.

Thus, it is possible to maintain the wavelength conversion efficiency of the blue light BL2 with the wavelength conversion element 441.

Further, it is possible to perform the temperature control of the second light emitting element 451 using the second thermoelectric conversion element 453 thermally coupled to the second light emitting element 451 via the second base 452. Thus, it is possible to stably output the red light RL with the second light emitting element 451.

Further, by performing the temperature control of the wavelength conversion element 441 and the temperature control of the second light emitting element 451 using the respective thermoelectric conversion elements 443, 453, it is possible to adjust the white balance of the light emitted from the light source device 4.

Therefore, it is possible to project the image light formed based on the illumination light WL good in white balance.

The light source device 4 is provided with the heat receiving member 47.

The heat receiving member 47 transports the heat which is transferred from the first thermoelectric conversion element 443 and the heat which is transferred from the second thermoelectric conversion element 453, to the radiation member 48. In other words, the heat receiving member 47 is provided with a function as a first heat receiving member for transporting the heat which is transferred from the first thermoelectric conversion element 443, to the radiation member 48, and a function as a second heat receiving member for transporting the heat which is transferred from the second thermoelectric conversion element 453, to the radiation member 48.

According to such a configuration, due to the heat receiving member 47, it is possible to efficiently transport the heat of the wavelength conversion element 441 to the radiation member 48 from the first thermoelectric conversion element 443, and in addition, it is possible to efficiently transport the heat of the second light emitting element 451 to the radiation member 48 from the second thermoelectric conversion element 453. Therefore, it is possible to increase the cooling efficiency of each of the wavelength conversion element 441 and the second light emitting element 451.

In the light source device 4, the first heat receiving member and the second heat receiving member are constituted by the single heat receiving member 47.

According to such a configuration, it is possible to arrange the wavelength conversion element 441, the first base 442, the first thermoelectric conversion element 443, the second light emitting element 451, the second base 452, and the second thermoelectric conversion element 453 in the single heat receiving member 47. Thus, it is possible to reduce the number of components of the light source device 4, and thus, it is possible to reduce the size of the light source device 4.

Further, when the light source device 4 is provided with the chassis described above, by arranging the heat receiving member 47 in the chassis, it is possible to arrange the wavelength conversion device 44 and the second light source 45 inside the chassis, and in addition, it is possible to seal the chassis.

In the light source device 4, the heat receiving member 47 which functions as the first radiation member and the second radiation member is constituted by the vapor chamber.

Here, the vapor chamber is high in thermal diffusion efficiency in a plane.

Therefore, since the heat receiving member 47 is formed of the vapor chamber, it is possible to diffuse the heat which is transferred from the first thermoelectric conversion element 443 in the plane to transfer the heat to the radiation member 48. Thus, it is possible to increase a thermal transport efficiency to the radiation member 48. Similarly, it is possible to diffuse the heat transferred from the second thermoelectric conversion element 453 in a plane to transfer the heat to the radiation member 48. Thus, it is possible to increase the thermal transport efficiency to the radiation member 48.

Therefore, it is possible to increase the cooling efficiency of each of the wavelength conversion element 441 and the second light emitting element 451.

The light source device 4 is provided with the fan 49 for circulating the airflow through the radiation member 48 which functions as the first radiation member and the second radiation member.

According to such a configuration, it is possible to increase the radiation efficiency by the radiation member 48 by the fan 49 circulating the airflow through the radiation member 48. Therefore, it is possible to increase the cooling efficiency of each of the wavelength conversion element 441 and the second light emitting element 451.

The control processing described above is performed on the light source device 4 provided with the first light emitting element 411 for outputting the blue light BL, the wavelength conversion element 441 for outputting the wavelength-converted light YL obtained by converting the wavelength of the blue light BL2 entering the wavelength conversion element 441 from the first light emitting element 411, and the second light emitting element 451 for outputting the red light RL to be combined with the blue light BL1 and the wavelength-converted light YL.

The control processing includes the cooling processing SA for cooling the wavelength conversion element 441, the first cooling processing SB for cooling the second light emitting element 451, and the second cooling processing SC and the warming processing SD for controlling the temperature of the second light emitting element 451 based on the ratio B/R between the light intensity of the blue light BL1 and the light intensity of the red light RL, the blue light BL1 and the red light RL being included in the light output from the light source device 4.

The cooling processing SA corresponds to a first cooling procedure, and the first cooling processing SB corresponds to a second cooling procedure.

The second cooling processing SC and the warming processing SD correspond to an adjustment procedure.

According to such a configuration, since the wavelength conversion element 441 is cooled in the cooling processing SA, it is possible to maintain the wavelength conversion efficiency of the blue light BL2 with the wavelength conversion element 441. Further, since the second light emitting element 451 is cooled in the first cooling processing SB, it is possible to stably output the red light RL from the second light emitting element 451.

Further, since the temperature of the second light emitting element 451 is controlled based on the ratio B/R described above in the second cooling processing SC and the warming processing SD, it is possible to control the light intensity of the red light RL output from the second light emitting element 451, and by extension, it is possible to adjust the white balance of the light output from the light source device 4. Modifications of First Embodiment

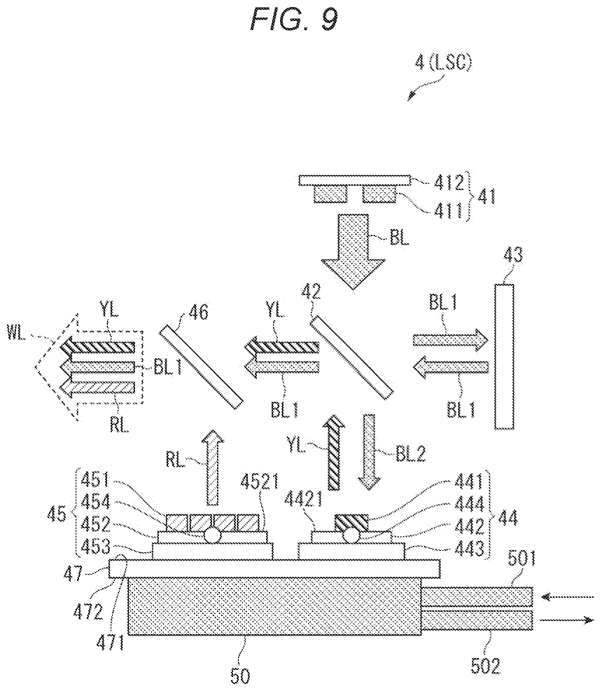

FIG. 9 is a schematic diagram showing the light source device 4 in which a radiation member 50 as a modification of the radiation member 48 is adopted.

In the projector 1 described above, it is assumed that the radiation member 48 is a heatsink for releasing the heat from the plurality of fins 481, the heat being transferred from each of the wavelength conversion element 441 and the second light emitting element 451. However, this is not a limitation, and the configuration of the radiation member 48 can be other configurations.

For example, it is possible to adopt the radiation member 50 shown in FIG. 9 in the light source device 4 instead of the radiation member 48 and the fan 49.

The radiation member 50 is a container through which the cooling liquid can circulate, and a so-called cold plate. The radiation member 50 has an introduction part 501 for introducing the cooling liquid supplied by a pump not shown to the inside, a discharge part 502 for discharging the cooling liquid having circulated inside, and a plurality of radiator fins not shown disposed inside. The radiation member 50 releases the heat transferred from the heat receiving member 47 from the plurality of radiator fins to the cooling liquid.

When such a radiation member 50 is adopted in the light source device 4 instead of the radiation member 48 and the fan 49, it is sufficient to increase or decrease the flow rate of the cooling liquid circulating through the radiation member 50 in the steps SA4, SB4, SC4, and SD1 for increasing/decreasing the output of the fan 49 in the control processing described above.

### Second Embodiment

Then, a second embodiment of the present disclosure will be described.

The projector according to the present embodiment is provided with substantially the same configuration as that of the projector 1 according to the first embodiment, but is different in the point that the heat receiving member, the radiation member, and the fan are disposed so as to correspond to each of the wavelength conversion device 44 and the second light source 45. It should be noted that in the following description, a part which is the same or substantially the same as the part having already been described is denoted by the same reference symbol to omit the description thereof.

### Schematic Configuration of Projector

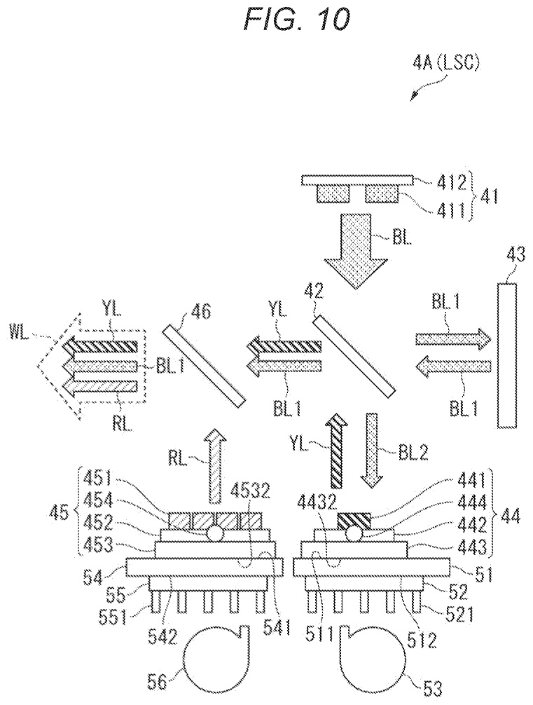

FIG. 10 is a schematic diagram showing a configuration of the light source device 4A provided to the projector according to the present embodiment.

The projector according to the present embodiment is provided with substantially the same configuration and functions as those of the projector 1 according to the first embodiment except the point that the projector according to the present embodiment is provided with the light source device 4A shown in FIG. 10 instead of the light source device 4 according to the first embodiment. In other words, the light source control device LSC according to the present embodiment is provided with the light source device 4A and the control unit 7.

### Configuration of Light Source Device

As shown in FIG. 10, the light source device 4A is provided with substantially the same configuration and the functions as those of the light source device 4 according to the first embodiment except the point that the light source 4A is provided with a first heat receiving member 51, a first radiation member 52, a first fan 53, a second heat receiving member 54, a second heat receiving member 55, and the second fan 56 instead of the heat receiving member 47, the radiation member 48, and the fan 49.

The first heat receiving member 51, the first radiation member 52, and the first fan 53 are disposed so as to correspond to the wavelength conversion device 44.

The first heat receiving member 51 is a substrate which supports the wavelength conversion device 44, and at the same time, receives the heat from the wavelength conversion device 44. The first heat receiving member 51 has a first placement surface 511 and a first radiation surface 512.

On the first placement surface 511, there is arranged the first thermoelectric conversion element 443 so that the second surface 4432 of the first thermoelectric conversion element 443 has contact with the first placement surface 511.

The first radiation surface 512 is a surface at an opposite side to the first placement surface 511 in the first heat receiving member 51. On the first radiation surface 512, there is arranged the first radiation member 52.

Such a first heat receiving member 51 is formed of the vapor chamber similarly to the heat receiving member 47. However, this is not a limitation, and the first heat receiving member 51 can be a metal member good in thermal conductivity.

The first radiation member 52 is arranged at an opposite side to the first base 442 with respect to the first thermoelectric conversion element 443, and is thermally coupled to the first thermoelectric conversion element 443 via the first heat receiving member 51. The first radiation member 52 releases the heat of the wavelength conversion device 44 transferred via the first heat receiving member 51. In detail, the first radiation member 52 releases the heat of the wavelength conversion element 441 transferred via the first base 442, the first thermoelectric conversion element 443, and the first heat receiving member 51. Such a first radiation member 52 is formed of a heatsink which has a plurality of fins 521, and which releases the heat transferred from the first heat receiving member 51 from the plurality of fins 521.

The first fan 53 is controlled by the control unit 7 to suction the gas in the exterior housing 2 and circulate the airflow through the first radiation member 52.

It should be noted that it is possible to adopt a radiation member having substantially the same configuration as that of the radiation member 50 related to the modification of the first embodiment described above as the first radiation member instead of the first radiation member 52 and the first fan 53.

The second heat receiving member 54, the second radiation member 55, and the second fan 56 are disposed so as to correspond to the second light source 45, and are separated from the first heat receiving member 51. Specifically, in the present embodiment, the wavelength conversion device 44 and the second light source 45 are not thermally coupled to each other, but are separated from each other.

The second heat receiving member 54 is a substrate which supports the second light source 45, and at the same time, receives the heat from the second light source 45. The second heat receiving member 54 has a second placement surface 541 and a second radiation surface 542.

On the second placement surface 541, there is arranged the second thermoelectric conversion element 453 so that the second surface 4532 of the second thermoelectric conversion element 453 has contact with the second placement surface 541.

The second radiation surface 542 is a surface at an opposite side to the second placement surface 541 in the second heat receiving member 54. On the second radiation surface 542, there is arranged the second radiation member 55.

Such a second heat receiving member 54 is formed of the vapor chamber similarly to the heat receiving member 47 and the first heat receiving member 51. However, this is not a limitation, and the second heat receiving member 54 can be a metal member good in thermal conductivity. Further, it is also possible to use the vapor chamber as at least one of the first heat receiving member 51 and the second heat receiving member 54, and use a thermal conduction member such as metal as the other thereof. Thus, it is possible to prevent a rise in material cost.

It should be noted that when the light source device 4A is provided with a chassis for housing the first light source 41, the first color combining element 42, the diffuse reflective element 43, the wavelength conversion device 44, the second light source 45, and the second color combining element 46, at least one of the first heat receiving member 51 and the second heat receiving member 54 can be used as the closing member for closing the chassis. In this case, it is possible to arrange a radiation member to which the heat is transferred via the at least one of the heat receiving members, outside the chassis.

The second radiation member 55 is arranged at an opposite side to the second base 452 with respect to the second thermoelectric conversion element 453, and is thermally coupled to the second thermoelectric conversion element 453 via the second heat receiving member 54. The second radiation member 55 releases the heat of the second light source 45 transferred via the second heat receiving member 54. In detail, the second radiation member 55 releases the heat of the second light emitting element 451 transferred via the second base 452, the second thermoelectric conversion element 453, and the second heat receiving member 54. Such a second radiation member 55 is formed of a heatsink which has a plurality of fins 551, and which releases the heat transferred from the second heat receiving member 54 from the plurality of fins 551.

The second fan 56 is controlled by the control unit 7 independently of the first fan 53 to suction the gas in the exterior housing 2 and circulate the airflow through the second radiation member 55.

It should be noted that it is possible to adopt a radiation member having substantially the same configuration as that of the radiation member 50 as the second radiation member instead of the second radiation member 55 and the second fan 56.

In the projector provided with such a light source device 4, the control unit 7 executes substantially the same control processing as the control processing according to the first embodiment.

In the present embodiment, the control unit 7 increases the output of the first fan 53 by 10% in the step SA4 in the cooling processing SA of the wavelength conversion element 441 in the control processing.

Further, the control unit 7 increases the output of the second fan 56 by 10% in the step SB4 in the first cooling processing SB and the step SC4 in the second cooling processing SC of the second light emitting element 451 in the control processing. The control unit 7 reduces the output of the second fan 56 by 10% in the step SD1 in the warming processing SD of the second light emitting element 451.

In addition, the control unit 7 controls the output of the first fan 53 when controlling the output of the fan to control the temperature and the output of the wavelength conversion element 441, and controls the output of the second fan 56 when controlling the output of the fan to control the temperature and the output of the second light emitting element 451.

### Advantages of Second Embodiment

The projector according to the present embodiment described hereinabove exerts substantially the same advantages as those of the projector 1 according to the first embodiment.

### Modifications of Embodiments

The present disclosure is not limited to each of the embodiments described above, but includes modifications, improvements, and so on in the range in which the advantages of the present disclosure can be achieved.

In each of the embodiments described above, it is assumed that the control unit 7 controls not only the operations of the light source device 4, but also the overall operations of the projector 1. However, this is not a limitation, and the control unit 7 can be a controller for controlling only the configuration of the light source device 4.

In each of the embodiments described above, it is assumed that the control unit 7 performs the cooling of the wavelength conversion element 441 in priority to the cooling of the second light emitting element 451. However, this is not a limitation, and it is possible for the control unit 7 to perform the cooling of the second light emitting element 451 in priority to the cooling of the wavelength conversion element 441.

In the first embodiment described above, it is assumed that the light source device 4 is provided with the fan 49 for circulating the airflow through the radiation member 48, and in the second embodiment described above, it is assumed that the light source device 4A is provided with the first fan 53 for circulating the airflow through the first radiation member 52 and the second fan 56 for circulating the airflow through the second radiation member 55. However, this is not a limitation, and the light source devices 4, 4A are not required to be provided with the fan. Further, it is possible for the light source device 4A to be provided with a single fan for circulating the airflow through the first radiation member 52 and the second radiation member 55.

In each of the embodiments described above, it is assumed that the control unit 7 performs the cooling of the wavelength conversion element 441 with the first thermoelectric conversion element 443 in priority to the fan 49, 53 in the cooling processing SA. However, this is not a limitation, and it is possible for the control unit 7 to perform the cooling of the wavelength conversion element 443 with the fan 49, 53 in priority to the first thermoelectric conversion element 443 in the cooling processing SA.

In each of the embodiments described above, it is assumed that the control unit 7 reduces the output of each of the first light emitting element 411 and the second light emitting element 451 when the temperature of the wavelength conversion element 441 has exceeded the first threshold value after performing the cooling of the wavelength conversion element 441 with the first thermoelectric conversion element 443 and the cooling of the wavelength conversion element 441 with the fan 49, 53 in the cooling processing SA. However, this is not a limitation, and when the temperature of the wavelength conversion element 441 has exceeded the first threshold value even after cooling the wavelength conversion element 441 with the first thermoelectric conversion element 443 and the fan 49, 53, it is possible for the control unit 7 to execute the step S6 of shutting down the projector 1.

In each of the embodiments described above, it is assumed that the control unit 7 performs the cooling of the second light emitting element 451 with the second thermoelectric conversion element 453 in priority to the fan 49, 53 in the first cooling processing SB and the second cooling processing SC. However, this is not a limitation, and it is possible for the control unit 7 to perform the cooling of the second light emitting element 451 with the fan 49, 53 in priority to the second thermoelectric conversion element 453 in the cooling processing SB, SC.

In each of the embodiments described above, it is assumed that the control unit 7 reduces the output of each of the first light emitting element 411 and the second light emitting element 451 when the temperature of the second light emitting element 451 has exceeded the second threshold value after performing the cooling of the second light emitting element 451 with the second thermoelectric conversion element 453 and the cooling of the second light emitting element 451 with the fan 49, 56 in the first cooling processing SB. However, this is not a limitation, and when the temperature of the second light emitting element 451 has exceeded the second threshold value even after cooling the second light emitting element 451 with the second thermoelectric conversion element 453 and the fan 49, 56, it is possible for the control unit 7 to execute the step S6 of shutting down the projector 1.

In each of the embodiments described above, it is assumed that the control unit 7 controls the ratio B/R of the light intensity of the blue light BL1 to the light intensity of the red light RL, the blue light BL1 and the red light RL being included in the illumination light WL output from the light source device 4, 4A, using the first thermoelectric conversion element 443, the second thermoelectric conversion element 453, and the fans 49, 53, 56. However, this is not a limitation, and it is possible for the control unit 7 to control the ratio B/R with only either one of the thermoelectric conversion elements 443, 453 and the fans 49, 53, 56, or to control the electric power to be supplied to the light emitting elements 411, 451 instead of, or in addition to, the control described above.

In the first embodiment described above, it is assumed that the light source device 4 is provided with the single heat receiving member 47 for supporting the wavelength conversion device 44 and the second light source 45, the single radiation member 48 disposed on the heat receiving member 47, and the fan 49 for circulating the airflow through the radiation member 48. In the second embodiment described above, it is assumed that the light source device 4A is provided with the first heat receiving member 51, and first radiation member 52, and the first fan 53 disposed so as to correspond to the wavelength conversion device 44, and the second heat receiving member 54, the second radiation member 55, and the second fan 56 disposed so as to correspond to the second light source 45. However, this is not a limitation, and the numbers of the heat receiving members, the radiation members, and the fans are not limited to those described above. For example, it is possible to arrange the first radiation member 52 and the second radiation member 55 on the single heat receiving member 47 for supporting the wavelength conversion device 44 and the second light source 45.

In each of the embodiments described above, it is assumed that the image forming device 34 is provided with the three light modulation elements 343R, 343G, and 343B. However, this is not a limitation, and it is possible for the image forming device 34 to be provided with two or less, or four or more light modulation elements.

In each of the embodiments described above, it is assumed that the image projection unit 3 has the configuration in which the optical components are arranged in a substantially L-shape in a plan view as shown in FIG. 1. However, this is not a limitation, and it is possible for the image projection unit 3 to have a configuration having, for example, a substantially U-shape in the plan view.

In each of the embodiments described above, it is assumed that the light modulation elements 343 are each formed of the transmissive liquid crystal panel having the plane of incidence of light and the light exit surface different from each other. However, this is not a limitation, and the light modulation elements 343 can each be formed of a reflective liquid crystal panel in which the plane of incidence of light and the light exit surface are the same. Further, it is also possible to adopt a light modulation element other than the liquid crystal element such as an element using a micromirror such as a DMD (Digital Micromirror Device) as the light modulation element 343 providing the light modulation element is capable of modulating the incident light beam to form the image corresponding to the image information.

In each of the embodiments described above, there is cited the example in which the light source device 4, 4A and the light source control device LSC are applied to the projector. However, this is not a limitation, and the light source device and the light source control device according to the present disclosure can also be applied to electronic equipment such as an illumination device.

### Conclusion of Present Disclosure

Hereinafter, the conclusion of the present disclosure will supplementarily be noted.

### Supplementary Note 1

A light source control device configured to output illumination light including a first light emitting element configured to output blue light, a second light emitting element configured to output red light, a wavelength conversion element configured to convert the blue light entering the wavelength conversion element into wavelength-converted light, a first thermoelectric conversion element thermally coupled to the wavelength conversion element, a first radiation member thermally coupled to the first thermoelectric conversion element, a second thermoelectric conversion element thermally coupled to the second light emitting element, a second radiation member thermally coupled to the second thermoelectric conversion element, and a controller configured to control drive of each of the first thermoelectric conversion element and the second thermoelectric conversion element.

According to such a configuration, it is possible to control the temperature of the wavelength conversion element and the temperature of the second light emitting element by the controller controlling the first thermoelectric conversion element and the second thermoelectric conversion element. Thus, it is possible to maintain the wavelength conversion efficiency of the wavelength conversion element, and in addition, it is possible to stabilize the output of the red light by the second light emitting element. Therefore, it is possible to adjust the white balance of the illumination light output from the light source control device.

### Supplementary Note 2

In the light source control device described in Supplementary Note 1, the controller is configured to perform cooling of the wavelength conversion element with the first thermoelectric conversion element in priority to cooling of the second light emitting element with the second thermoelectric conversion element.

According to such a configuration, since the conversion efficiency into the wavelength-converted light can be maintained, it is possible to prevent the white balance from being dramatically lost. Further, by cooling the wavelength conversion element in priority to the second light emitting element, it is possible to prevent the deterioration of the wavelength conversion element.

### Supplementary Note 3

In the light source control device described in one of Supplementary Note 1 and Supplemental Note 2, there is further included a fan configured to circulate an airflow through each of the first radiation member and the second radiation member, wherein the controller is configured to control drive of the fan.

According to such a configuration, it is possible to increase the radiation efficiency by the radiation members by the fan circulating the airflow through each of the radiation members. Therefore, it is possible to increase the cooling efficiency of each of the wavelength conversion element and the second light emitting element.

### Supplementary Note 4

In the light source control device described in Supplementary Note 3, the controller is configured to perform cooling of the wavelength conversion element with the first thermoelectric conversion element in priority to the fan.

According to such a configuration, since the cooling with the first thermoelectric conversion element higher in cooling efficiency than the fan is performed in priority to the cooling with the fan when cooling the wavelength conversion element, it is possible to promptly perform the cooling of the wavelength conversion element.

Further, when the wavelength conversion element is sufficiently cooled by the first thermoelectric conversion element, there is no need to increase the output of the fan. In such a case, it is possible to prevent the sound noise of the fan from increasing, and by extension, it is possible to achieve a reduction in sound noise of the light source control device.

### Supplementary Note 5

In the light source control device described in one of Supplementary Note 3 and Supplemental Note 4, the controller is configured to reduce an output of each of the first light emitting element and the second light emitting element when temperature of the wavelength conversion element exceeds a threshold value for the wavelength conversion element after performing the cooling of the wavelength conversion element with the first thermoelectric conversion element and the cooling of the wavelength conversion element with the fan.

According to such a configuration, since the light intensity of the blue light input to the wavelength conversion element reduces although the luminance of the light output from the light source control device is reduced by reducing the output of the first light emitting element, it is possible to lower the temperature of the wavelength conversion element.

Further, by reducing not only the output of the first light emitting element, but also the output of the second light emitting element, it is possible to make it easy to maintain the white balance of the light output from the light source control device.

### Supplementary Note 6

In the light source control device described in any one of Supplementary Note 3 through Supplementary Note 5, the controller is configured to perform the cooling of the second light emitting element with the second thermoelectric conversion element in priority to the fan.

According to such a configuration, since the cooling with the second thermoelectric conversion element higher in cooling efficiency than the fan is performed in priority to the cooling with the fan when cooling the second light emitting element, it is possible to promptly perform the cooling of the second light emitting element.

Further, when the second light emitting element is sufficiently cooled by the second thermoelectric conversion element, there is no need to increase the output of the fan. In such a case, it is possible to prevent the sound noise of the fan from increasing, and by extension, it is possible to achieve a reduction in sound noise of the light source control device.

### Supplementary Note 7

In the light source control device described in Supplementary Note 6, the controller is configured to reduce an output of each of the first light emitting element and the second light emitting element when temperature of the second light emitting element exceeds a threshold value for the second light emitting element after performing the cooling of the second light emitting element with the second thermoelectric conversion element and the cooling of the second light emitting element with the fan.

According to such a configuration, since an amount of heat generated in the second light emitting element reduces although the luminance of the light output from the light source control device is reduced by reducing the output of the second light emitting element, it is possible to lower the temperature of the second light emitting element.

Further, by reducing not only the output of the second light emitting element, but also the output of the first light emitting element, it is possible to make it easy to maintain the white balance of the light output from the light source control device.

### Supplementary Note 8

In the light source control device described in any one of Supplementary Note 3 through Supplementary Note 7, the controller is configured to control a ratio of a light intensity of the blue light included in the illumination light to a light intensity of the red light included in the illumination light with the first thermoelectric conversion element, the second thermoelectric conversion element, and the fan.

According to such a configuration, since it is possible to control the temperature of the wavelength conversion element using the first thermoelectric conversion element and the fan, and it is possible to control the temperature of the second light emitting element using the second thermoelectric conversion element and the fan, it is possible to control the light intensity of each of the blue light, the wavelength-converted light, and the red light output from the light source control device. Therefore, it is possible to maintain the white balance of the illumination light output from the light source control device.

### Supplementary Note 9

In the light source control device described in Supplementary Note 8, the controller is configured to perform the cooling of the second light emitting element using the second thermoelectric conversion element and the fan when reducing the ratio.

According to such a configuration, by cooling the second light emitting element with the second thermoelectric conversion element and the fan, it is possible to increase the output of the red light by the second light emitting element. Therefore, it is possible to reduce the ratio.

### Supplementary Note 10

In the light source control device described in Supplementary Note 9, the controller is configured to reduce an output of the blue light of the first light emitting element when the ratio fails to reach an upper limit value after performing the cooling of the second light emitting element with the second thermoelectric conversion element and the cooling of the second light emitting element with the fan.

Here, when the ratio described above has not reached the upper limit value even after performing the cooling of the second light emitting element with the second thermoelectric conversion element and the fan, it is assumed that the output of the red light by the second light emitting element has reduced. In such a case, it is possible to reduce the ratio described above by the controller reducing the output of the blue light by the first light emitting element.

### Supplementary Note 11

In the light source control device described in any one of Supplementary Note 8 through Supplementary Note 10, the controller is configured to warm the second light emitting element using the second thermoelectric conversion element and the fan when raising the ratio.

According to such a configuration, by warming the second light emitting element, it is possible to reduce the output of the red light by the second light emitting element. Thus, it is possible to raise the ratio described above.

### Supplementary Note 12

In the light source control device described in Supplementary Note 11, the controller is configured to reduce an output of the red light by the second light emitting element when the ratio fails to reach a lower limit value after performing the warming of the second light emitting element with the second thermoelectric conversion element and the warming of the second light emitting element with the fan.

According to such a configuration, when the ratio described above has not reached the lower limit value even after performing the warming of the second light emitting element with the second thermoelectric conversion element and the fan when raising the ratio described above, it is possible to reduce the light intensity of the red light output from the second light emitting element by the controller reducing the output of the second light emitting element. Therefore, it is possible to raise the ratio.

### Supplementary Note 13

A projector including the light source control device described in any one of Supplementary Note 1 through Supplementary Note 12, an image forming device configured to form image light from the light emitted from the light source control device, and a projection optical device configured to project the image light formed by the image forming device.

According to such a configuration, it is possible to exert substantially the same advantages as those of the light source control device described above, and it is possible to project the image light which is formed based on the illumination light good in white balance.

### Supplementary Note 14

A light source device including a first light source configured to output blue light, a second light source configured to output red light, a wavelength conversion device configured to convert the blue light entering the wavelength conversion device into wavelength-converted light, a color combining element configured to combine the blue light, the wavelength-converted light, and the red light with each other, a first radiation member thermally coupled to the wavelength conversion device, and a second radiation member thermally coupled to the second light source, wherein the wavelength conversion device includes a wavelength conversion element configured to convert the blue light into the wavelength-converted light, a first base which has a first surface and a second surface at an opposite side to the first surface, which supports the wavelength conversion element with the first surface, and which has thermal conductivity, and a first thermoelectric conversion element thermally coupled to the second surface, the second light source includes a light emitting element, a second base which has a third surface and a fourth surface at an opposite side to the third surface, which supports the light emitting element with the third surface, and which has thermal conductivity, and a second thermoelectric conversion element thermally coupled to the fourth surface, the first radiation member is arranged at an opposite side to the first base with respect to the first thermoelectric conversion element, and is thermally coupled to the first thermoelectric conversion element, and the second radiation member is arranged at an opposite side to the second base with respect to the second thermoelectric conversion element, and is thermally coupled to the second thermoelectric conversion element.

According to such a configuration, it is possible to perform the temperature control of the wavelength conversion element using the first thermoelectric conversion element thermally coupled to the wavelength conversion element via the first base. Thus, it is possible to maintain the wavelength conversion efficiency of the blue light with the wavelength conversion element.

Further, it is possible to perform the temperature control of the second light emitting element using the second thermoelectric conversion element thermally coupled to the second light emitting element via the second base. Thus, it is possible to stably output the red light with the second light emitting element.

Further, by performing the temperature control of the wavelength conversion element and the temperature control of the second light emitting element using the respective thermoelectric conversion elements, it is possible to adjust the white balance of the light emitted from the light source device.

### Supplementary Note 15

In the light source device described in Supplementary Note 14, there are further included a first heat receiving member configured to transport heat transferred from the first thermoelectric conversion element, to the first radiation member, and a second heat receiving member configured to transport heat transferred from the second thermoelectric conversion element, to the second radiation member.

According to such a configuration, due to the first heat receiving member, it is possible to efficiently transport the heat of the wavelength conversion element to the first radiation member from the first thermoelectric conversion element, and due to the second heat receiving member, it is possible to efficiently transport the heat of the second light emitting element to the second radiation member from the second thermoelectric conversion element. Therefore, it is possible to increase the cooling efficiency of each of the wavelength conversion element and the second light emitting element.

### Supplementary Note 16

In the light source device described in Supplementary Note 15, the first heat receiving member and the second heat receiving member are formed of a single heat receiving member.

According to such a configuration, it is possible to arrange the wavelength conversion element, the first base, the first thermoelectric conversion element, the second light emitting element, the second base, and the second thermoelectric conversion element in the single heat receiving member. Thus, it is possible to reduce the number of components of the light source device, and thus, it is possible to reduce the size of the light source device.

### Supplementary Note 17

In the light source device described in one of Supplementary Note 15 and Supplemental Note 16, at least one of the first heat receiving member and the second heat receiving member is formed of a vapor chamber.

Here, the vapor chamber is high in thermal diffusion efficiency in a plane. The heat receiving member formed of the vapor chamber is capable of diffusing the heat transferred from the thermoelectric conversion element in the plane to transfer the heat to the radiation member. Thus, it is possible to increase the thermal transport efficiency to the radiation member.

Therefore, when the heat receiving member is formed of the vapor chamber, it is possible to diffuse the heat which is transferred from the first thermoelectric conversion element in the plane to transfer the heat to the first radiation member. Thus, it is possible to increase the thermal transport efficiency to the first radiation member. Similarly, it is possible to diffuse the heat transferred from the second thermoelectric conversion element in a plane to transfer the heat to the second radiation member. Thus, it is possible to increase the thermal transport efficiency to the second radiation member.

Therefore, it is possible to increase the cooling efficiency of each of the wavelength conversion element and the second light emitting element.

On the other hand, by providing the heat receiving member with a configuration other than the vapor chamber, for example, a thermal conduction member such as metal, it is possible to achieve suppression of a rise in material cost and an increase in cooling efficiency.

### Supplementary Note 18

In the light source device described in any one of Supplementary Note 14 through Supplementary Note 17, there is further included a fan configured to circulate an airflow through the first radiation member and the second radiation member.

According to such a configuration, it is possible to increase the radiation efficiency by the radiation members by the fan circulating the airflow through each of the radiation members. Therefore, it is possible to increase the cooling efficiency of each of the wavelength conversion element and the second light emitting element.

### Supplementary Note 19

A projector including the light source device described in any one of Supplementary Note 14 through Supplementary Note 18, an image forming device configured to form image light from the light emitted from the light source device, and a projection optical device configured to project the image light formed by the image forming device.

According to such a configuration, it is possible to exert substantially the same advantages as those of the light source device described above, and it is possible to project the image light which is formed based on the illumination light good in white balance.

### Supplementary Note 20

A method of controlling a light source to be performed on a light source device provided with a first light emitting element, a wavelength conversion element configured to output wavelength-converted light obtained by converting a wavelength of blue light input from the first light emitting element, and a second light emitting element configured to output red light to be combined with the blue light and the wavelength-converted light, the method including a first cooling step of cooling the wavelength conversion element, a second cooling step of cooling the second light emitting element, and a control step of controlling temperature of the second light emitting element based on a ratio between a light intensity of the blue light included in light output from the light source device and a light intensity of the red light included in the light output from the light source device.

According to such a configuration, since the wavelength conversion element is cooled in the first cooling step, it is possible to maintain the wavelength conversion efficiency of the blue light with the wavelength conversion element. Further, since the second light emitting element is cooled in the second cooling step, it is possible to stably output the red light from the second light emitting element.

Further, since the temperature of the second light emitting element is controlled based on the ratio described above in the control step, it is possible to control the light intensity of the red light output from the second light emitting element, and by extension, it is possible to adjust the white balance of the light output from the light source device.

What is claimed is:

1. A light source control device configured to output illumination light comprising:
a first light emitting element configured to output blue light;
a second light emitting element configured to output red light;
a wavelength conversion element configured to convert the blue light entering the wavelength conversion element into wavelength-converted light;
a first thermoelectric conversion element thermally coupled to the wavelength conversion element;
a first radiation member thermally coupled to the first thermoelectric conversion element;
a second thermoelectric conversion element thermally coupled to the second light emitting element;
a second radiation member thermally coupled to the second thermoelectric conversion element; and
a controller configured to control drive of each of the first thermoelectric conversion element and the second thermoelectric conversion element.

2. The light source control device according to claim 1, wherein
the controller is configured to perform cooling of the wavelength conversion element with the first thermoelectric conversion element in priority to cooling of the second light emitting element with the second thermoelectric conversion element.

3. The light source control device according to claim 1, further comprising:
a fan configured to circulate an airflow through each of the first radiation member and the second radiation member, wherein
the controller is configured to control drive of the fan.

4. The light source control device according to claim 3, wherein
the controller is configured to perform cooling of the wavelength conversion element with the first thermoelectric conversion element in priority to the fan.

5. The light source control device according to claim 4, wherein
the controller is configured to reduce an output of each of the first light emitting element and the second light emitting element when temperature of the wavelength conversion element exceeds a threshold value for the wavelength conversion element after performing the cooling of the wavelength conversion element with the first thermoelectric conversion element and the cooling of the wavelength conversion element with the fan.

6. The light source control device according to claim 3, wherein
the controller is configured to perform the cooling of the second light emitting element with the second thermoelectric conversion element in priority to the fan.

7. The light source control device according to claim 6, wherein
the controller is configured to reduce an output of each of the first light emitting element and the second light emitting element when temperature of the second light emitting element exceeds a threshold value for the second light emitting element after performing the cooling of the second light emitting element with the second thermoelectric conversion element and the cooling of the second light emitting element with the fan.

8. The light source control device according to claim 3, wherein
the controller is configured to control a ratio of a light intensity of the blue light included in the illumination light to a light intensity of the red light included in the illumination light with the first thermoelectric conversion element, the second thermoelectric conversion element, and the fan.

9. The light source control device according to claim 8, wherein
the controller is configured to perform the cooling of the second light emitting element using the second thermoelectric conversion element and the fan when reducing the ratio.

10. The light source control device according to claim 9, wherein
the controller is configured to reduce an output of the blue light of the first light emitting element when the ratio fails to reach an upper limit value after performing the cooling of the second light emitting element with the second thermoelectric conversion element and the cooling of the second light emitting element with the fan.

11. The light source control device according to claim 8, wherein
the controller is configured to warm the second light emitting element using the second thermoelectric conversion element and the fan when raising the ratio.

12. The light source control device according to claim 11, wherein
the controller is configured to reduce an output of the red light by the second light emitting element when the ratio fails to reach a lower limit value after performing the warming of the second light emitting element with the second thermoelectric conversion element and the warming of the second light emitting element with the fan.

13. A projector comprising:
the light source control device according to claim 1;
an image forming device configured to form image light from the light emitted from the light source control device; and
a projection optical device configured to project the image light formed by the image forming device.

14. A light source device comprising:
a first light source configured to output blue light;
a second light source configured to output red light;
a wavelength conversion device configured to convert the blue light entering the wavelength conversion device into wavelength-converted light;
a color combining element configured to combine the blue light, the wavelength-converted light, and the red light with each other;
a first radiation member thermally coupled to the wavelength conversion device; and
a second radiation member thermally coupled to the second light source, wherein
the wavelength conversion device includes
a wavelength conversion element configured to convert the blue light into the wavelength-converted light,
a first base which has a first surface and a second surface at an opposite side to the first surface, which supports the wavelength conversion element with the first surface, and which has thermal conductivity, and
a first thermoelectric conversion element thermally coupled to the second surface,
the second light source includes
a light emitting element,
a second base which has a third surface and a fourth surface at an opposite side to the third surface, which supports the light emitting element with the third surface, and which has thermal conductivity, and
a second thermoelectric conversion element thermally coupled to the fourth surface,
the first radiation member is arranged at an opposite side to the first base with respect to the first thermoelectric conversion element, and is thermally coupled to the first thermoelectric conversion element, and
the second radiation member is arranged at an opposite side to the second base with respect to the second thermoelectric conversion element, and is thermally coupled to the second thermoelectric conversion element.

15. The light source device according to claim 14, further comprising:
a first heat receiving member configured to transport heat transferred from the first thermoelectric conversion element, to the first radiation member; and
a second heat receiving member configured to transport heat transferred from the second thermoelectric conversion element, to the second radiation member.

16. The light source device according to claim 15, wherein
the first heat receiving member and the second heat receiving member are formed of a single heat receiving member.

17. The light source device according to claim 15, wherein
at least one of the first heat receiving member and the second heat receiving member is formed of a vapor chamber.

18. The light source device according to claim 14, further comprising:
a fan configured to circulate an airflow through the first radiation member and the second radiation member.

19. A projector comprising:
the source device according to claim 14;
an image forming device configured to form image light from the light emitted from the light source device; and
a projection optical device configured to project the image light formed by the image forming device.

20. A method of controlling a light source to be performed on a light source device provided with a first light emitting element, a wavelength conversion element configured to output wavelength-converted light obtained by converting a wavelength of blue light input from the first light emitting element, and a second light emitting element configured to output red light to be combined with the blue light and the wavelength-converted light, the method comprising:
a first cooling step of cooling the wavelength conversion element;
a second cooling step of cooling the second light emitting element; and
a control step of controlling temperature of the second light emitting element based on a ratio between a light intensity of the blue light included in light output from the light source device and a light intensity of the red light included in the light output from the light source device.
